(19) United States
(12) Patent Application Publication
(10) Pub. No.: US 2018/0336450 A1
(43) Pub. Date: Nov. 22, 2018

(54) Platform to Acquire and Represent Human Behavior and Physical Traits to Achieve Digital Eternity

(71) Applicant: Forever Identity, Inc., New York, NY (US)

(72) Inventors: Fabrizio Gramuglio, Genova (IT); Giorgio Manfredi, Milano (IT)

(21) Appl. No.: 16/049,549

(22) Filed: Jul. 30, 2018

Related U.S. Application Data
(63) Continuation-in-part of application No. 14/532,324, filed on Nov. 4, 2014.
(60) Provisional application No. 61/900,550, filed on Nov. 6, 2013.

(51) Int. Cl. G06N 3/00; H04L 29/08

(52) U.S. Cl. CPC G06N 3/006; H04L 67/22; H04L 67/306

(57) ABSTRACT

An artificial intelligence platform that is capable of reproducing a person's identity and allowing others to interact with it is described. It does so by creating a Digital Identity, founded on the very concept of a Digital Soul capable of bringing back to life (mirroring) the physical aspect, behavior, emotions, mannerisms and relational sphere of the subject. Each Digital Identity is capable of interacting with its surroundings and of formulating specific responses based on an innovative knowledge base structure of the individual, his emotional background (psychological model) and relational structure (skills/aptitude). The artificial intelligence platform includes a hardware and software architecture capable of creating a digital artifact from a historical or living persona to represent his/her physical and psychological features. The digital artifact can manage a dialogue with a human interlocutor (or another digital system), react to incoming stimuli and show its proper behavior and emotions.

### CROSS-REFERENCE TO RELATED APPLICATIONS

The present application claims priority to and is a Continuation-In-Part Application of U.S. patent application Ser. No. 14/532,324 filed Nov. 4, 2014, which published as U.S. Patent Application Publication No. 20150127593 on May 7, 2015. The '324 application relies on the disclosure of and claims priority to and the benefit of the filing date of U.S. Provisional Application No. 61/900,550, filed Nov. 6, 2013. The disclosures of each of these applications are hereby incorporated by reference herein in their entireties.

### BACKGROUND OF THE INVENTION

### Field of the Invention

The present invention relates to artificial intelligence. More particularly, the present invention relates to an artificial intelligence platform comprising hardware and software for representing a human subject, real, historical or fictional, to one or more interlocutors through a dialogue.

### Description of Related Art

Since the time of cave dwellers man has gone to great lengths to ensure his name, deeds and thoughts will be remembered and cherished by future generations. This need has been, in all ages, in all cultures and in all social strata, one of the key characteristics of human nature and a key driver of history. Storytellers, portrait painters, bibliographers, photographers, memorial architects have, to various degrees, tried to address this need. U.S. Pat. No. 8,156,054 entitled “Systems and Methods for Managing Interactions Between an Individual and an Entity” assigned to AT&T, which is incorporated by reference herein in its entirety, describes a system to “retrieve collected information associated with a behavior of an individual, synthesize from the information a measure of a mood of the individual to interact with others, and transmit the measure to a system associated with the individual to manage requests between the individual and the entity.” Such systems, as well as legacy, memory, and identity preservation techniques existing today, fall short of being able to provide an artificial intelligence platform capable of providing responses from the subject that are consistent with an accurate portrayal of the subject.

### SUMMARY OF THE INVENTION

To this end, the present invention provides an artificial intelligence platform able to acquire, preserve and maintain the physical and immaterial legacy of a subject in order to reproduce his/her human behavior and identity, as well as permit dynamical interactions with future generations. This platform, also known as the Digital Identity, can be applied to any kind of 2D/3D representation of the human body and, using the five senses plus perception and intuition, it can understand the environment and the people around it. It captures the simultaneous stimuli coming from different sources and defines an intelligent answer based on the computation of different engines representing the human processes of intuition and perception and the human emotional process compared to moral and ethical values. The generated answer or answers derive from a customized knowledge base, such as a Memory Repository, containing the represented subject's memories in the form of texts, algorithms, images, sounds, videos and all the other digital representations of objects and concepts.

The generated answer can be played as dialogic mode supported by one or more of the related digital representations and can be presented in a form detectable by one or more of the five senses of the interlocutors.

Aspects of the invention include Aspect 1, which is an artificial intelligence platform for representing a subject as a Digital Identity to one or more interlocutors through a dialogue, comprising one or more or all of the following logical elements:

a Circum module operably configured for sensing information about an environment external to the Digital Identity;

a Societas module operably configured for identifying a level of intimacy

between the subject and another individual;

an Indoles module operably configured for determining emotional and psychological behavior of the subject;

an Animus module operably configured for storing memories of the subject and for determining an answer to interlocutor inquiries;

a Loquor module operably configured for interpreting verbal and/or non-verbal languages of the interlocutors and expressing answers to the interlocutors using verbal and/or non-verbal languages; and/or

a Corpus module operably configured for determining physical and/or voice characteristics of the subject and representing the characteristics to the interlocutors;

wherein:

multimodal inputs comprising explicit stimuli, non-explicit stimuli, evocative stimuli, and social stimuli are received by the Circum module, the Societas module, the Indoles module, and the Animus module;

the Circum module provides an output to the Societas module, the Indoles module, and the Animus module;

the Societas module provides an output to the Indoles module and the Animus module;

the Indoles module provides an output to the Animus module;

the Animus module provides an output to the Loquor module and to the Corpus module;

the Loquor module provides an output to the Corpus module; and

the Corpus module provides multimodal outputs and presents a representation of the digital identity of the subject of physical and voice characteristics of the subject based on the outputs of the Circum module, the Societas module, the Indoles module, the Animus module, and the Loquor module.

Aspect 2 is the artificial intelligence platform of Aspect 1, wherein the Circum module (module for sensing) comprises a multisensorial priority manager, and perception engine, and an intuition engine.

Aspect 3 is the artificial intelligence platform of Aspect 1 or 2, wherein the multimodal inputs are processed by a multisensorial priority manager which thereby sends outputs to a perception engine and intuition engine.

Aspect 4 is the artificial intelligence platform of any of Aspects 1-3, wherein the multisensorial priority manager comprises a multimodal interface and a multisensorial priority engine.

Aspect 5 is the artificial intelligence platform of an of Aspects 1-4, wherein the multisensorial priority engine assigns a weight to multimodal inputs.

Aspect 6 is the artificial intelligence platform of any of Aspects 1-5, wherein a perception engine uses a weight generated by a multisensorial priority engine and transforms non-explicit stimuli into explicit stimuli.

Aspect 7 is the artificial intelligence platform of any of Aspects 1-6, wherein the Societas module (means for providing a level of intimacy) manages access to stored information on the subject based on relationship values.

Aspect 8 is the artificial intelligence platform of any of Aspects 1-7, wherein the Societas module (means for providing a level of intimacy) comprises an identity catalogue of personal and biometric data about people identifiable by the platform, plus a permission rules and an intimacy management engine module.

Aspect 9 is the artificial intelligence platform of any of Aspects 1-8, wherein an intimacy management engine computes a total level of intimacy for the one or more interlocutors.

Aspect 10 is the artificial intelligence platform of any of Aspects 1-9, wherein a total level of intimacy is used by one or more logical elements to define an answer released to the one or more interlocutors.

Aspect 11 is the artificial intelligence platform of any of Aspects 1-10, wherein the level of intimacy is upgraded under the following conditions:

if the interlocutor is unknown, information collected during dialogue can modify parameters of a social group;

if the interlocutor is unknown, but the artificial intelligence platform collects sufficient data to identify him/her in a unique way;

if the interlocutor is known or unknown, but he/she is endorsed by a known interlocutor with sufficient intimacy status;

if the interlocutor is known, information collected during a dialogue with the interlocutor can modify parameters of a social group;

if the interlocutor is known but his/her number of occurrences exceeds a defined threshold.

Aspect 12 is the artificial intelligence platform of any of Aspects 1-11, wherein an emotional reasoning engine computes an emotional status of the artificial intelligence platform by:

detecting actual position in an emotional map;

receiving multimodal input's stimuli, fitted and elaborated by the Circum module (means for sensing) and the Societas module (means for providing a level of intimacy);

extracting by a memories repository of emotional values related at the ongoing dialogue; and

computing a next position in the emotional map function of actual position, emotional values received from the Circum module (means for sensing), emotional values received from the Societas module (means for producing a level of intimacy), and emotional values extracted from the memory repository.

Aspect 13 is the artificial intelligence platform of any of Aspects 1-12, wherein memories are stored in a memory repository.

Aspect 14 is the artificial intelligence platform of any of Aspects 1-13, wherein the memory repository and memories extraction are based on the following levels of information:

data necessary for contextualizing a memory comprising a timestamp of memory insertion, localization, age of the subject, taxonomic classification of the memory,

connection with other memories and references to different topics; a biographical memory comprising the subject's sentences, the subject's narration of an experience, external documents, videos, images, verbal audios and music;

sensorial stimuli comprising smells, sounds, taste, flavor descriptions and tactile descriptions;

identified people involved in a memory and their affiliation, at a relationship level,

to specific socio/demographic groups; and

emotional, ethical and moral values and tags.

Aspect 15 is the artificial intelligence platform of any of Aspects 1-14, wherein the Animus module (means for storing memories and deciding an answer) comprises a moral and ethical inferential engine (including ethical and religious rules fitted on the subject) and a decisional engine.

Aspect 16 is the artificial intelligence platform of any one of Aspects 1-15, wherein a decisional engine is configured to compute a correct answer to an interlocutor inquiry.

Aspect 17 is the artificial intelligence platform of any of Aspects 1-16, wherein the decisional engine is configured to compute a correct answer based on:

the multimodal inputs processed from the Circum module (means for sensing) and the Societas module (means for providing a level of intimacy);

data from the moral and ethical module;

emotional values computed by the emotional reasoning engine; and

the subject's memories and biography.

Aspect 18 is the artificial intelligence platform of any of Aspects 1-17, wherein a moral and ethical inferential engine applies a sentiment analysis on sentences to evaluate positive or negative relevance of multimodal inputs and related memories.

Aspect 19 is the artificial intelligence platform of any of Aspects 1-18, wherein the decisional engine computes a best answer through the following process:

filtering verbal stimuli by means of subjective NLP from the Loquor module (module for expressing);

translating non-verbal stimuli in textual descriptions from the Circum module (module for sensing);

recalling memories from the intuition engine;

finding and selecting memories that satisfy the stimuli through the use of semantic analysis based on texts, tags and/or descriptions; and

performing a computation to identify the best answer based on the selected memories.

Aspect 20 is the artificial intelligence platform of any of Aspects 1-19, wherein a decisional engine performs a computation to identify a best answer based on selected memories by comparing output of other logical elements with the following attributes of each selected memory:

the total level of intimacy;

the outputs of the Societas module (means for providing a level of intimacy); and

the outputs of the moral and ethical inferential engine.

Aspect 21 is the artificial intelligence platform of any of Aspects 1-20, wherein:

the total level of intimacy establishes which of the selected memories are compatible with the one or more interlocutors;

the outputs of the Societas module (means for providing a level of intimacy) allow it to obtain the emotional status of the artificial intelligence platform related to the multimodal inputs and related to each memory adopted as a possible answer; and the outputs of the moral and ethical inferential engine permit it to recognize the moral and ethical values related to the multimodal inputs.

Aspect 22 is the artificial intelligence platform of any of Aspects 1-21, wherein the Loquor module (means for expressing) comprises a subjective natural language generation service.

Aspect 23 is the artificial intelligence platform of any of Aspects 1-22, wherein the subjective natural language generation service comprises:

a library of phonemes;

a library of facial expressions;

prosody maps;

idiom maps; and

jargon maps.

Architecture of Digital Identity (DI): in embodiments the system is based on six different related logical elements: Circum, Corpus, Loquor, Indoles, Animus and Societas.

Circum manages the perception of the environment external to the DI. To do this Circum manages different sensors and actuators that emulate the five human senses (hearing, sight, smell, taste, and touch). After the collection of sensorial stimuli, Circum computes this input to decide the categorization and the relevance of these stimuli. As used in the context of this specification, “Circum” may be used interchangeably with “means for sensing” or “module operably configured for sensing.”

One aspect of Circum is that it is capable of filtering the five senses stimuli by a suitable set of algorithms representing a subject's specific sensibility in order to transduce biometrical inputs into a specific sensation.

Circum is capable of describing a cognitive matrix that stimulates the DI's perceptive system, capable of acquiring the different input stimuli and transmitting them in processed form to the other elements of DI's platform in order to obtain a decision about the right answers to deliver.

To manage the perception of the environment external to the DI, Circum uses the data managed by the Multisensorial Priority Manager and the algorithms of Perception Engine and Intuition Engine.

The Multisensorial Priority Manager contains a Multimodal/Multisensorial Interface and a Multisensorial Priority Engine able to assign different priorities to perceived inputs.

The Multisensorial Priority Manager categorizes the stimuli as:
Explicit stimuli: language stimuli consciously generated by the interlocutors.
Non-explicit stimuli: language stimuli unconsciously generated by the interlocutors.
Evocative stimuli: non-language stimuli unconsciously generated by the interlocutors or by the environment.
Social stimuli: stimuli derived by the level of intimacy of the interlocutors with respect to the subject.

Other categories can be introduced in the future.

The Multimodal/Multi-sensorial Interface enables the uncoupling of the environmental inputs perceived through the sensors (actuators) and their perceptive valence thus allowing the senses and the reactions they trigger in a Digital Identity to be kept distinct from their technological actuators.

The Multisensorial Priority Engine establishes the relevance of the perceived inputs. The decisions about relevance are based on the subject's personal history, sensibility, memories and behaviors.

The Perception Engine represents the capacity of the DI to understand the non-explicit stimuli coming from the environment and mix these with the explicit stimuli, in order to obtain the best perception on the events that occur in the DI's environment. To optimize the perceptual environment, the Perception Engine uses the weight generated by the Multisensorial Priority Engine and transforms the non-explicit stimuli into explicit stimuli. The words (or tags or symbols) used to describe the non-explicit stimuli depend on the weight assigned.

The Intuition Engine represents the capacity of the DI to generate new stimuli based on the original ones plus the relevance introduced by the Multisensorial Priority Engine and the redefinition computed by the Perception Engine.

To construct an intuition, the engine uses an appropriate classification of the subject's memories where each item is connected with the others by fuzzy logic. The intuition results from the application of artificial intelligence methods applied on data and inputs.

The intuition will be detected by the interlocutors as an answer (verbal or/and non-verbal) to the previous stimuli. This process will be repeated in order to collect new stimuli for the DI. These stimuli are re-analyzed by means of the Multisensorial Priority Engine and the Perception Engine. The results, inserted in the Intuition Engine, contribute to validate or discard the intuition.

In the intuition's process an analysis of facial similarity is applied. The face of each unknown interlocutor will be compared, by biometric methods, to the faces inserted in the knowledge of the DI. If the similarity passes a threshold value, the emotional attributes of the stored faces, in the DI's knowledge, will be used to compute the intuition.

The cycles of reiteration necessary to solve an intuition are structured in a way to obtain a reinforcement learning where, at the end, the intuition is adopted or discarded.

The Societas Module is a specific relational component tied to each subject's identity and relationships that gives/limits access to each specific piece of information. The Societas Module manages the access to stored information (memories, biography, etc.) filtering on relationship values such as relatives, friends, groups and interests. As used herein, “Societas” may be used interchangeably with “means for providing a level of intimacy” or “module operably configured for providing a level of intimacy.”

Societas comprises two modules: the Permission Rules and Identity Catalogue and the Intimacy Management Engine.

The Permission Rules and Identity Catalogue contain the personal and biometrical data about the individuals identifiable by the DI. Each of these individuals is connected by a set of attributes that identify their intimacy status with the DI and its social group.

The intimacy status is an integer that identifies the Level of Intimacy (LoI) of an interlocutor with the DI. The LoI is coupled with the number of occurrences that identify the number of relations occurred between the interlocutor and the DI.

The social groups are characterized by (1) their social values which for example can include one or more of gender, range of age, race, ethnicity, citizenship, religion, social class, level of study, kind of work, and similar values, (2) their emotional appeals, and (3) their ethical and moral values. The social values can be segmented in a more refined way. The emotional appeal will be catalogued in accordance to the Indoles's emotional parameters and, for the known person, are collected in the Memories Repository. The ethical and moral values will be catalogued in accordance with the ethical and moral values adopted in the Animus.

The Intimacy Management Engine computes the Total Level of Intimacy (LoI) of all the persons in front of the DI (in relation with the DI). Specific methods and equations for determining the Total LoI are provided in more detail below. In embodiments, the Total Level of Intimacy is the output of the Societas module. The Total LoI can be used by the other modules to define the quality of answer (in terms of content and verbal and non-verbal expressions) released to the set of interlocutors.

“Vigilance” is a function that represents the weight of vigilance that the DI uses to deliver an answer. The DI computes this weight starting from the quality of connections between the interlocutor and the known network of persons. This approach permits the DI to set the LoI by means of the personal parameters of the interlocutor and the influence of this interlocutor on the social network connected with DI.

The Intimacy Management Engine computes in a recursive way the Total LoI, based on the stimuli received. It starts with a Total LoI (t₀) and it modifies this value based on the new information accumulated during the session of dialogue between the interlocutors and the DI.

The LoI of each interlocutor will be upgraded in a different way:

a) if an interlocutor is unknown, the information collected during the dialogue can modify the parameters of social group;

b) If an interlocutor is unknown, but the DI collects enough data to identify him/her in a unique way (typically biometrical data) the intimacy status is upgraded;

c) If the interlocutor is known or unknown, but he/she is endorsed by a known interlocutor with sufficient intimacy status, he/she can obtain an intimacy status upgrade;

d) If the interlocutor is known, the information collected during the dialogue can modify the parameters of social group and, eventually, the intimacy status will be upgraded;

e) If the interlocutor is known but his/her number of occurrences exceeds a defined threshold, eventually, the intimacy status will be upgraded.

The DI's subject defines all the weights, thresholds, and other elements used to determine a temporary or lasting variation of LoI.

The Indoles Module defines the specific emotional and psychological model of Digital Identity constructed from those available in the literature or tailored specifically to the user one is representing. The Indoles Module contains the n-dimensional map of the emotional states and the psychological model that defines the transition rules from one emotional status to another. As used herein, the term “Indoles” may be used interchangeably with “means for determining emotional behavior” or “module operably configured for determining emotional behavior.”

The Indoles Module transforms each Digital Identity's dialogue into an n-dimensional point into the map of emotions calculated by means of the emotional attribute of a specific stored memory.

The Indoles Module includes the parameters to set the correct facial expression and movements of body and hands for a 2D/3D representation and to set the voice synthesis.

The Indoles Module is composed of four sub-modules: the Emotional Map, the Emotional Behavior Function, the Emotional Reasoning Engine and the Emotional Representation Function.

The Emotional Map describes the possible range of emotions that the DI can assume. This map is unique for all the DIs created and summarizes the state of the art of the study on human emotion.

The Emotional Behavior Function describes the behavior of the subject into the emotional map. This function traces the possible paths that the subject can use into the map.

The Emotional Reasoning Engine computes the emotional status of the DI, with one or more of the following steps: 1) detection of the actual position in the Emotional Map; 2) reception of the input's stimuli, fitted and elaborated by Circum and Societas; 3) extraction by the Memories Repository (see below in the Animus element) of the emotional values related to the ongoing dialogue; and 4) computation of the next position in the Emotional Map function of: actual position, emotional values received from Circum, emotional values received from Societas, and emotional values extracted from Memories Repository (which in the context of this specification may also be referred to as a Memory Repository).

With the absence of any kind of stimuli, in each time interval the Emotional Behavior Function computes a new position on the emotional map.

The Emotional Representation Function separates the emotions felt by the DI from those expressed. This function uses correction parameters of emotional behavior arrived from Animus. These parameters are used to compute the new position in the Emotional Map.

The Emotional Representation Function defines the boundaries, in the Emotional Map, of the emotions that the DI is able to show.

The Animus is the representation of the subject's memories, of its capacity to compute a decision based on the data known, and his/her ethical and moral values. The Animus is structured around a storage and computing system in which the subject's memories are related to the subject's emotions, his/her sensations, his/her prosodic, lexical, moral, religious and psychological characteristics and other personal attributes connected with the memories. As used herein, “Animus” may be used interchangeably with “means for storing memories and/or deciding an answer” or “module operably configured for storing memories and/or deciding an answer.”

Animus, together with Indoles, receives data from Circum and Societas. They process these inputs and pass the results to the Loquor and Corpus for the right representation of the answers.

The memories are perpetuated and stored in the Memory Repository, a highly structured organic framework based on multiple levels of information, including one or more of:

i. the data necessary to contextualize the memory: timestamp of memory insertion, localization, timeframe of memories (age of the subject), taxonomic classification of the memory, connection with other memories and references to the different topics;

ii. the biographical memory in different form: the subject's sentences (texts), the subject's narration of an experience (texts), external documents, videos, images, verbal audios, and music, etc.;

iii. Sensorial stimuli: smells, sounds, taste and flavor descriptions, tactile descriptions;

iv. The identified people involved in the memory and their affiliation, at a relationship level, to specific socio/demographic groups. This results in providing or limiting access to each specific piece of information. Thus, access to information is specific to determined circles of relations;

v. The emotional, ethical and moral values and tags, which are used, based on predetermined models, to compute the emotional and moral reaction applicable to each specific memory.

In order to protect the private data of the subjects, the Memory Repository preserves the memories using encryption techniques with public or private keys.

The memories are catalogued in the Repository by means of different ontologies related to the subject. The search (and extraction) of the memories related to an input stimulus is developed using the subjective semantic analysis of the input stimulus (see Loquor described below).

The Animus also includes different computational modules: a Moral and Ethical Module that holds the ethical and religious rules fitted to the subject and a Decisional Engine to compute the right answer.

The Decisional Engine to compute the right answer can be based on any one or more or different combinations of:

a. the input's stimuli manipulated from Circum and Societas,

b. data from the Moral and Ethical Module,

c. the emotional values computed by Emotional Reasoning Engine,

d. In addition, subject memories and biography.

This approach enables the generation of a specific response adapted to a determined situation, question and/or stimuli, even if they are already known and classified in the Animus, or never encountered before (not classified in the Animus memories or biography).

The Moral and Ethical Module is composed by two main parts: the Moral and Ethical Assertions Repository and the Moral and Ethical Inferential Engine.

The Moral and Ethical Assertions Repository is a database of sentences that define the positive or negative value of an action or a thought. The set is divided in subsets, each of these representing a collection of sentences unified by a moral. Each subject can have more than one moral (including sentences in contrast).

Modification at the standard morals or creation of new morals will be applied during the memories data collection phase.

The database of the Moral and Ethical Assertions Repository is indexed in a way to simplify the research of sentences.

The Moral and Ethical Inferential Engine (M&E Engine) searches in the indexed database of the Moral and Ethical Repository all the sentences that may be possible responses/answers/arguments provided in response to when a memory is stimulated by the inputs. The possible responses/answers/arguments are identified by the tags or by the values stored in the Moral and Ethical Repository and connected with the specific memory. The Moral and Ethical Inferential Engine applies a sentiment analysis on the sentences to evaluate the positive or negative relevance of the stimulus and of the related memories.

The results of this analysis may increase or decrease the moral and ethical relevance of the stimulus.

The Decisional Engine is an artificial intelligence (A.I.) engine able to decide the right answer, selected among the memories extracted from the Memory Repository, based on the criteria obtained from Circum, Societas, Indoles and the M&E Engine. The main steps of the process to select the best answer can include one or more of the following:

i. From Loquor, the verbal stimuli (phrases) are filtered by means of the subjective NLP;

ii. From Circum, the non-verbal stimuli (translated in textual descriptions);

iii. From the Intuition Engine the memories are recalled by the intuition (these memories have a different relevance);

iv. Using the semantic analysis, based on texts, tags and descriptions, the Decisional Engine finds, and extracts, all the memories that satisfy the received stimuli;

v. The Decisional Engine starts the computation to identify the best answer based on the selected memories. For the computation the Decisional Engine compares the output of other modules with the following attributes of each selected memory:

a. The Total LoI (output of Societas) establishes which among the selected memories are compatible with the interlocutors;

b. The outputs of Indoles that allow it to obtain the emotional status of DI related to the present stimuli and the emotional status of DI related to each memory adopted as a possible answer;

c. The outputs of the M&E Engine that permit it to recognize the moral and ethical values related to the received stimuli;

d. A dedicated algorithm compares the relevance of the emotional impact of the stimuli, and the related memories, with the relevance of their own moral impact. This algorithm is set by psychologists during the analysis of the subject's personality phase of the DI configuration;

e. The algorithm's result can modify the Total LoI value. In this case the steps b will be repeated and if a new set of selected memories is obtained, the steps c and d will be repeated to obtain a stable result.

Loquor: a module for expressing answers and reactions of the subject represented by the Digital Identity. The Loquor module represents the dialogical capacities of the Digital Identity. This capacity is split into two main branches: one devoted to understand the verbal and non-verbal languages of the interlocutors and the other one to express, by means of verbal and non-verbal languages, the answers and reactions to the input stimuli from the environment and the interlocutors. As used in this specification the term “Loquor” may be used interchangeably with “means for expressing” or “module operably configured for expressing answers and reactions.”

Nonverbal languages, pauses and prosody can be influenced by components of the persona, where language inflection is influenced by the relational apparatus and will therefore reflect the user's affiliation/belonging to a specific social structure.

Subjective NLP Service and Ontologies are devoted to the identification of meaning of an input's stimuli and its capability for creating a connection with the individual's ontologies of the Digital Identity. To obtain this, the Loquor: a) receives the input (verbal or text) and, by means of a Subjective NLP Service and Subjective Ontologies, understands the “common meaning” and the “intimate meaning” of the phrases and b) solves by means of searches and extractions of content from the subject's memories (e.g. memories represented in the Memories Repository).

A multi-level catalogue of the different ontologies related to the subject is created where the native language spoken by the subject (Language Ontology) is mandatory. In addition, other optional ontologies are created: one dedicated to the subject's individual expertise and environment (Cultural-Group Ontologies), those regarding social dialogue (Social Dialogue Ontology), and those created especially for a specific user (User Ontology). A subjective NLP service uses the previous ontologies to understand the “common meaning” and the “intimate meaning” of the verbal and non-verbal messages.

The Subjective NLG Service and the Related Library are devoted to express, by means of verbal and non-verbal languages, the DI's answers and reactions and are connected with the NLG (Natural language Generation) service. The main components of this branch are the different kinds of libraries:

i. the library of phonemes for the Text-To-Speech customized on the subject;

ii. the library of the facial expression, customized on the subject.

Both the libraries have some special add-on:

iii. Prosody is a matrix that transforms the emotions (received from the Emotional Representation Function) into sequences of verbal and non-verbal elements selected from the libraries;

iv. Idioms & Jargon Maps are special sub-libraries that collect the typical expressions of the subject represented by the Digital Identity. Similarly to the NLP branch, Idioms & Jargons Maps are divided into five categories: universals, locals, sectorial, relatives and personals.

The DI can change the level of formality of the output language based on the DI behavior, the argument being made, and the interlocutors. The default is a more nested (personal) lexicon and according to the context level, it rises towards a broader level. It is therefore necessary that each element of the nested lexicon must have semantic correspondence to the upper level. The Subjective NLG Service can decide when and how much information is lost compared to how much is understood by the interlocutor by lowering the level of formality.

The Digital Identity, through Circum, Societas, Indoles, Animus and Loquor, aims to provide an answer that is consistent with the subject's know-how, personality, knowledge, and with his/her will, and, overall, ensures that the process of understanding the questions and of the stimuli is tailored around to the subject's experience.

The Presentation layer (Corpus), or interface, of each Digital Identity will be a hyper-realistic representation of the user. It will be obtained through different advanced techniques capable of best representing both the physical characteristics (bone, muscle and the skin) and the voice (inflection, changes in tone, etc.) of the subject. As used herein, the term “Corpus” may be used interchangeably with “means for representing” or “module operably configured for representing one or more characteristic of the subject.”

The presentation layer can be static or can change in time. It can move (change emotion, voice inflection, posture and gesture) based on the indications it is given by the Animus and by the dialogical state.

The presentation layer communicates with the Animus through a communication protocol that enables the decoupling of the presentation layer, technology dependent, from the decisional one tied to the Animus.

### BRIEF DESCRIPTION OF THE DRAWINGS

The accompanying drawings illustrate certain aspects of embodiments of the present invention and should not be used to limit or define the invention. Together with the written description the drawings serve to explain certain principles of the invention.

FIG. 1 is a schematic diagram showing representative Digital Identity (DI) logical elements according to embodiments of the invention.

FIG. 2 is a schematic diagram showing how the environment may interact with the DI according to embodiments.

FIG. 3 is a schematic diagram showing a representative way in which the Societas and the environment may interact and showing how this interaction may influence the DI's answers.

FIG. 4 is a schematic diagram showing a representative way in which the Indoles and other elements may interact and how this interaction may be used to influence the DI's answers.

FIG. 5 is a schematic diagram showing representative relationships between Animus and other modules.

FIG. 6 is a schematic diagram showing representative relationships between Loquor and other modules.

FIG. 7 is a schematic diagram showing a system including various external hardware components according to an embodiment of the invention.

FIG. 8 is a schematic diagram showing an information processing system according to an embodiment of the invention.

FIG. 9 is a schematic diagram showing an information acquisition process according to an embodiment of the invention.

FIG. 10 is a schematic diagram showing a process which can be used to extract physical characteristics and behavior information according to an embodiment of the invention.

FIG. 11 is a schematic diagram showing a process which can be used to capture features of the actor according to an embodiment of the invention.

FIG. 12 is a schematic diagram showing a process executed by the Multisensorial Priority Manager according to an embodiment of the invention.

FIG. 13 is a schematic diagram showing an information processing system and its output according to an embodiment of the invention.

FIG. 14 is a schematic diagram showing three hardware modules connected together and their output according to an embodiment of the invention.

FIG. 15 is a schematic diagram showing the character's memory module and its output according to an embodiment of the invention.

FIG. 16 is a schematic diagram showing the character's physical features module and its output according to an embodiment of the invention.

FIG. 17 is a schematic diagram showing the character's emotion and reasoning module and its output according to an embodiment of the invention.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The present invention introduces a new platform able to create, manage and preserve a dynamic legacy (called “Digital Identity” or “DI”). The platform is able to acquire, preserve and maintain the physical and immaterial legacy of a subject in order to reproduce their human behavior and identity and permit dynamical interactions with future generations.

The Digital Identity can be applied to any kind of 2D/3D representation of the human body and, using one or more of the five senses plus perception and intuition, can understand the environment and the people around it. It captures one or more sequential and/or simultaneous stimuli coming from the same or different sources and defines an intelligent answer based on the computation of one or more engines representing the human processes of intuition and perception and the human emotional process compared to moral and ethical values. The generated answer(s) are derived from a customized knowledge base, such as a Memory Repository, containing the representative subject's memories in the form of texts, algorithms, images, sounds, videos and all the other digital representations of objects and concepts.

The generated answer will be played as dialogic mode supported by all the related digital representations and presented in a form detectable by one or more of the five senses of the interlocutors.

Systems of the present invention can include one or more processors, such as a central processing unit or a graphics processing unit or both. The systems can comprise memory for storing data and/or instructions for operating the system. A computer is preferably used to process the data and to facilitate interaction between the subject and an individual. Such systems can comprise a video display, speakers, a keyboard, a mouse, disk drive, and/or microphone for facilitating the interactions. The computer can be configured for processing such information over a network, such as the internet. Processing instructions for implementing anyone or more of the operations outlined in this specification can be stored on a machine-readable medium (also known as a non-transitory computer-readable medium as defined below). Systems and methods disclosed in this specification can be executed as software programs run by a computer processor. For example, one or more method steps of any method described herein can be provided as computer-executable instructions and can be embedded on physical media, such as a hard drive or compact disc or jump drive, etc., and executed by a computer processor. The computer-executable instructions can be programmed in any suitable programming language, including JavaScript, C, C#, C++, Java, Python, Perl, Ruby, Swift, Visual Basic, and Objective C. By such programming the computer-executable instructions, code, or software instruct a processor to carry out the operations, commands, and logical elements of the Digital Entity described herein.

A skilled artisan will further appreciate, in light of this disclosure, how the invention can be implemented, in addition to software, using one or more hardware or firmware. For example, the hardware can be or can include one or more hardware modules for performing one or more specific operation, process, command, method, algorithm, logical element or other task described in this disclosure. As such, the Digital Entity disclosed herein can be implemented in a system comprising any combination of software, hardware, or firmware. In the context of this specification, the term “firmware” can include any software programmed onto a hardware device, such as a computer's nonvolatile memory. Thus, systems of the invention can also include, alternatively or in addition to the computer-executable instructions, various hardware modules and/or firmware modules configured to perform the operations and commands of the Digital Entity or represent its logical elements.

The hardware and/or firmware modules can perform the functions of one or more or all of the following logical elements described below. As used in the context of this specification, the term “hardware” includes, but is not limited to, one or more physical computer component such as a central processing unit, monitor, keyboard, computer data storage, graphics card, sound card, motherboard, circuit board, hard disk drive, optical disk drive, expansion card, and the like. In the context of this specification, the term “hardware module” can include any one or more of these components.

The computer data storage can be or can include any non-transitory computer storage media, such as RAM, which stores a set of computer executable instructions (software) for instructing the processors to carry out any of the methods, operations, and/or logical elements described in this disclosure. As used in the context of this specification, a “non-transitory computer-readable medium (or media)” can include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The non-transitory computer readable media can include the set of computer-executable instructions for providing an operating system as well as one or more sets of computer-executable instructions, or software, for implementing any of the methods, operations, and/or logical elements of the invention.

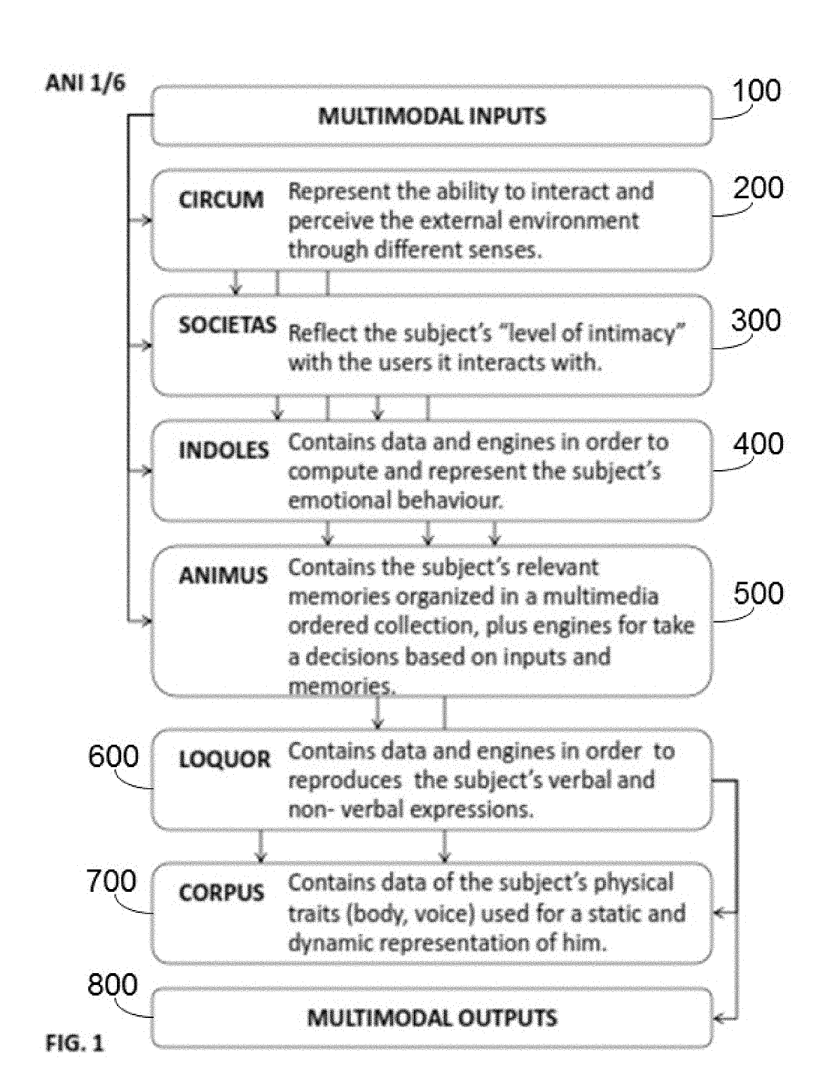

Specifically, in one embodiment a DI is made up of six main logical elements as shown in FIG. 1: Circum 200, Societas 300, Indoles 400, Animus 500, Loquor 600 and Corpus 700. The DI receives Multimodal Inputs 100, which pass to the Circum 200, Societas 300, Indoles 400, and Animus 500. These components pass outputs to the Loquor 600 and Corpus 700, which pass Multimodal Outputs 800 from the DI.

First Element of Digital Identity (DI): Circum 200.

DI can work using holograms, touchscreens, integrated in robots technologies or integrated in a web social platform.

The first logical element of the DI is the Circum 200: this element manages the perception of the environment external to the DI. In order to function this way, the Circum 200 manages different sensors and actuators that emulate the five human senses (hearing, sight, smell, taste, and touch). After collection of sensorial stimuli, the Circum 200 computes this input in order to categorize and decide relevance of these stimuli.

The Circum 200 could integrate a new approach of perception and intuition where the five senses are not only determined by biometrical parameters, but they are also filtered by a suitable set of algorithms representing a subject's specific sensibility in order to transduce biometrical inputs in a specific sensation (for example: he experienced the smell of fear).

Other than being able to perceive and analyze input in the above-described manner, this module can interact with the environment and generate an answer (based on up to 5 senses) which is then transmitted through its multimodal/multi-sensorial interface.

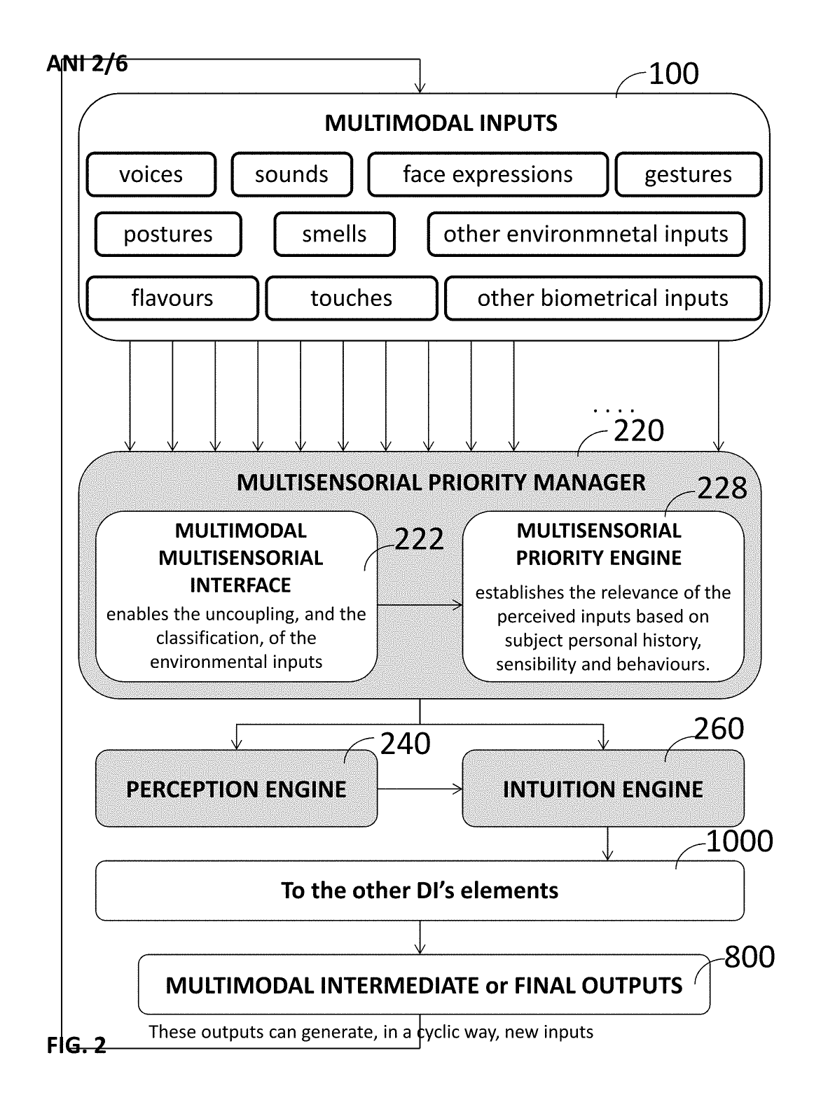

The interaction with the environment and the way it could influence the DI is shown in FIG. 2. First, Multimodal Inputs 100 are received from one or more sensors, including voices, sounds, face expressions, gestures, postures, smells, other environmental inputs, flavors, touches, and other biometrical inputs. The Multimodal Inputs 100 are then received by the Multisensorial Priority Manager 220, which comprises the Multimodal Multisensorial Interface 222 and the Multisensorial Priority Engine 228. The Multimodal Multisensorial Interface 222 enables the uncoupling and the classification of the environmental inputs, while the Multisensorial Priority Engine 228 establishes the relevant of the perceived inputs based on subject personal history, sensibility and behaviors. After being processed by the Multisensorial Priority Manager 220, the Multimodal Inputs 100 are received by both the Perception Engine 240 and Intuition Engine 260. The Perception Engine 240 also sends input to the Intuition Engine 160. The Intuition Engine 260 then sends the processed Multimodal Inputs to the other DI elements 1000, which subsequently sends them to the Multimodal Intermediate or Final Outputs 800. These outputs can generate, in a cyclic way, new inputs, thus repeating the process.

As shown in FIG. 2, for this computation, Circum 200 mainly uses data managed by the Multisensorial Priority Manager 220 and the algorithms of the Perception Engine 240 and Intuition Engine 260.

The Multisensorial Priority Manager 220 contains a Multimodal/Multisensorial Interface 222 and a Multisensorial Priority Engine 228 which is able to assign different priorities to perceived inputs.

The Multimodal/Multi-sensorial Interface 222 enables the uncoupling of the environmental inputs perceived through the sensors (actuators) and their perceptive valence thus allowing the senses (e.g.: smell) and the reactions they trigger in a Digital Identity to be kept distinct from their technological actuators. The Multimodal/Multi-sensorial Interface 222 categorizes the stimuli as:
explicit stimuli: language stimuli consciously generated by the interlocutors;
non-explicit stimuli: language stimuli unconsciously generated by the interlocutors;
evocative stimuli: the non-language stimuli unconsciously generated by the interlocutors or by the environment;
Social stimuli are the stimuli derived by the level of intimacy of the interlocutors.

The Multisensorial Priority Engine 228 establishes the relevance of the perceived inputs. Decisions about relevance can be based on subject personal history, sensibility, memories and behaviors. Subject personal history, sensibility, memories and behaviors are stored and catalogued by the other logical elements of the platform.

An Example of the Multisensorial Priority Manager's activity is as follows:

1) The DI platform, through the multimodal/multi-sensorial interface, receives and recognizes different simultaneous stimuli as inputs, for example:
Three people are in the room, and one of them is recognized as a good friend, and the other two are unknown;
The friend tells the DI: “Hi, I want to introduce you to my colleagues,” but
The DI recognizes a nervous behavior based on fear;
The DI recognizes that all the unknown persons have a perplexed behavior;
One of the unknown persons emanates a recognized smell;

2) The DI platform categorizes these stimuli as:
Three people in the room: as social stimulus;
The friend talking to the DI: as explicit language stimulus;
The DI recognizing a nervous behavior based on fear: as non-explicit language stimulus;
The DI recognizing that all the unknown persons have a perplexed behavior: as non-explicit language stimulus;
One of the unknown persons emanates a recognized smell: as evocative stimulus;

3) The DI platform, through the Multisensorial Priority Engine 228, assigns a weight of each single input based on the subject's personal history, sensibility, memories and behaviors. These weights can range for example from 0-100% and any number falling within this range. In the Example:
35% to the presence of unknown persons in the DI's environment. This is because the represented subject takes care of the differences between his public appearances versus his private appearances;
30% to the good friend's fear. This is because the represented subject has a good rapport with his friend;
20% to the meaning of the good friend's speech. This is because the represented subject gives more weight to non-verbal communication compared to verbal communication;
10% to the behavior of the unknown persons. This because the represented subject also observes the environment in addition to the interlocutor;
5% to the smell of the unknown person. This is because the represented subject thinks that the appearance and smell of each person (as in outfit, perfume, accessories, etc.) represent the person as he/she is.

4) The received stimuli and the results of the Multisensorial Priority Manager 220 are transmitted to the Perception Engine 240 and Intuition Engine 260.

The other two modules that compose the Circum 200 are the Perception Engine 240 and the Intuition Engine 260.

The Perception Engine 240 represents the capacity of the DI to understand the non-explicit stimuli coming from the environment and includes these with the explicit stimuli, in order to obtain the best perception on the events that occur around the DI. To optimize the perceived environment, the Perception Engine 240 uses the weight generated by the Multisensorial Priority Engine 228 and transforms the non-explicit stimuli into explicit stimuli. The words (or tags or symbols) used to describe the non-explicit stimuli are dependent on the weight assigned.

The following is an Example of the Perception Engine's activity:

Using the above example the Perception Engine 240 receives from the Multisensorial Priority Manager 220 the five simultaneous inputs with the weights added and considers the two non-explicit stimuli based on body language:
A nervous behavior of the friend, based on fear;
A perplexed behavior of the unknown persons.

The Perception Engine transforms these two non-verbal messages into verbal messages that enrich the original verbal message coming from the Multisensorial Priority Manager 240.

In the Example the verbal message: “Hi, I want introduce my colleagues to you” becomes:

“This is George, my friend”+“I am in your environment”+“I want to introduce my colleagues”+“Be careful of what you say. These aren't my friends and they can generate problems for me at work.”+“They are my friend's colleagues and they are hesitant, but not with a negative impression, about DI.”

The words used to describe the non-explicit stimuli are dependent on the weight assigned to the stimuli by the Multisensorial Priority Engine 228.

The Intuition Engine 260 represents the capacity of the DI to generate new stimuli based on the original ones plus the relevance introduced by the Multisensorial Priority Engine 228 and the redefinition computed by the Perception Engine. To construct an intuition, the engine uses an opposite classification of the subject's memories, where each item is connected with the others by fuzzy logic. In embodiments, fuzzy, fuzzy values, or fuzzy logic in the context of this specification can mean that possible answers are aggregated into a dimensional spectrum instead of absolute true/false designations as in classical logic. In contrast, fuzzy logic includes 0 and 1 as extreme cases of truth as well as various intermediate states of truth. For example, where an answer calls for identifying whether the environment is cold or hot, the answer may be expressed as a degree of coldness (0.45) or a degree of hotness (0.55). This type of logic is similar to how human brains operate, where data is aggregated to form partial truths, which partial truths are then aggregated into higher truths, which higher truths can then cause certain motor responses (such as removing a hand from a hot stove) when a particular threshold is exceeded. The intuition born from the application of artificial intelligence methods (i.e. by methods based on neural networks) applies to the data and inputs.

In the intuition's process an analysis of facial similarity is applied. The face of each unknown interlocutor will be compared, by biometrical methods, to the faces inserted in the knowledge of the DI. If the similarity passes a threshold value, the emotional attributes of the stored faces, in the DI's knowledge, will be used to compute the intuition.

The intuition will be detected by the interlocutors as an answer (verbal or/and non-verbal) to the previous stimuli.

This process will be reiterated in order to collect new stimuli for the DI. These stimuli are re-analyzed by means of the Multisensorial Priority Engine 228 and the Perception Engine 240. The results, inserted in the Intuition Engine 260, contribute to validate or discard the intuition.

The cycles of reiteration are structured in a way to obtain a reinforcement learning where, at the end, the intuition is adopted or discarded.

The following is an Example of the Intuition Engine's activity:

1) Using the above Example the Intuition Engine receives from the Multisensorial Priority Manager the five simultaneous inputs with the weights added and considers the evocative stimuli (one in the Example above):
One of the unknown persons emanates a recognized smell.

2) Based on the information stored in the subject's memories, the Intuition Engine collects a set of values related to the stimulus (e.g. a type of cologne). These fuzzy values represent the persistence of connection of this stimulus with the other items of the subject's memories and his ethical and emotional assertions. In the Example, this type of cologne is strongly associated with the ethical values of honesty and rightness. This is because in the subject's memories this perfume is associated with his grandfather and he is associated with the values of honesty and righteousness.

3) The Intuition Engine generates a new explicit stimulus to add to the previous ones. The new stimuli's collection becomes “This is George, my friend”+“I am in your environment”+“I want to introduce my colleagues to you”+“Be careful of what you say—these aren't my friends and they can generate problems for me at work.”+“They are my friend's colleagues and they are hesitant, but not with a negative impression, about DI”+“My intuition detects that probably one of these colleagues is an honest and righteous man.”

4) These are the Circum's output transmitted to the other elements of the DI platform. These outputs allow it to generate an intermediate answer able to enforce, weaken or solve the DI's intuition.

5) If the DI's intuition is not solved the process 1-4 are repeated.

6) If the DI's intuition is solved the fuzzy values that represent the persistence of connection of this stimulus with the specific items of the subject's memories and his ethical and emotional assertions, are upgraded.

In summary, the Circum describes a cognitive matrix that stimulates the DI's perceptual system, acquiring the different input stimuli and transmitting them, repeatedly, to the other elements of DI's platform in order to obtain a decision about the right answers to deliver.

Second Element of Digital Identity: Societas 300

In order to allow the Digital Identity an exhaustive understanding of external environments the present inventors introduce Societas 300: a specific logic element tied to each subject's identity and relationships.

Societas 300 gives/limits access to each specific piece of information. Stored information (memories, biography, etc.) are not accessible to all interlocutors, but information access is filtered on relationships values such as relatives, friends, groups and interests.

For example, the same question asked by two different interlocutors may therefore generate responses that are different in content, emotional reaction, prosody, gestures, etc.

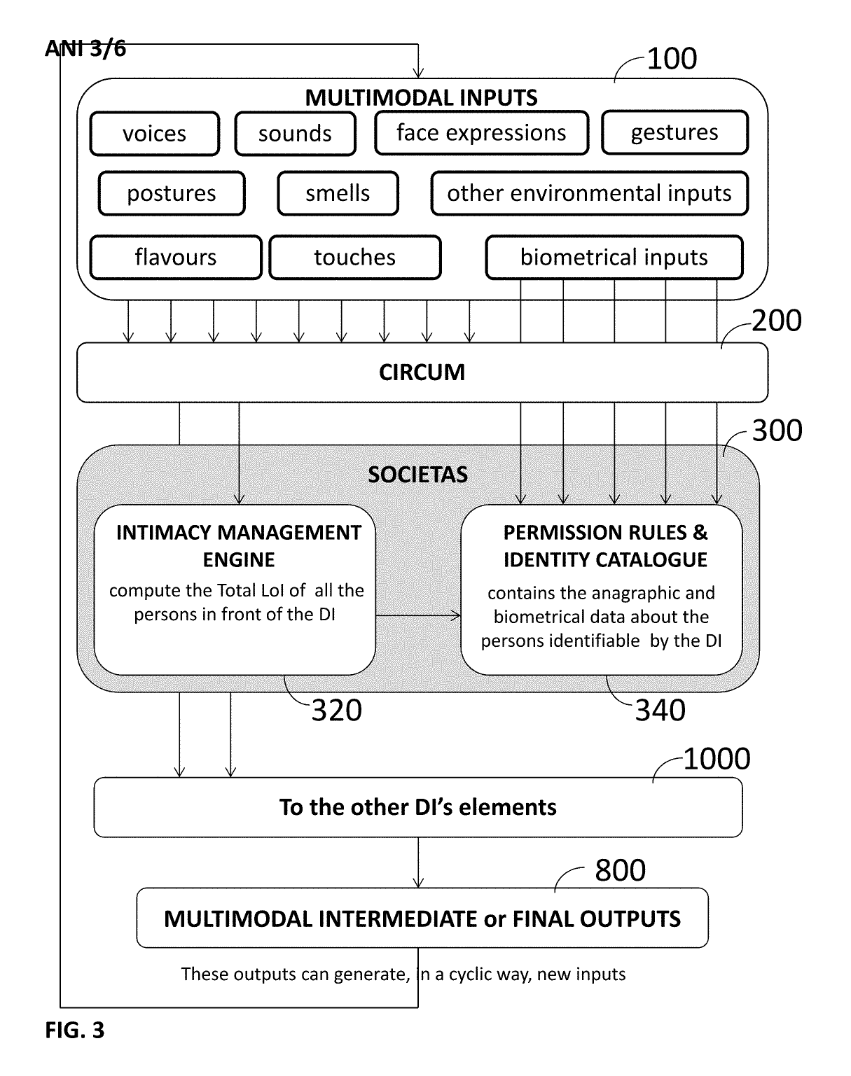

The interaction between Societas 300 with the environment and the way it influences the DI's answers is shown in FIG. 3. First, the Multimodal Inputs 100 described previously are received by the Circum 200, except for the biometrical inputs which are received by the Permission Rules and Identity Catalogue 340. Further, the Intimacy Management Engine 320 receives input from the Circum 200, which sends an output to the Permission Rules and Identity Catalogue 340. The output of the Intimacy Management Engine 320 is the total Level of Intimacy of all the persons in front of the DI. The Permission Rules and Identity Catalogue 340 contains the anagraphic and biometrical data about the persons identifiably by the DI. The total Level of Intimacy is outputted from Societas 300 to the other DI's elements 1000, which sends an output to the Multimodal Intermediate or Final Outputs 800. These outputs then can generate, in a cyclic way, new inputs, thus repeating the process.

As shown in FIG. 3, Societas 300 is composed of two modules:

a) The Permission Rules and Identity Catalogue 320 and

b) The Intimacy Management Engine 340.

The Permission Rules and Identity Catalogue 320 contains the personal and biometrical data of the persons identifiable by the DI. Each person is connected to a set of attributes that identify him/her, his/her intimacy status with the DI and his/her social group.

The intimacy status is an integer that identifies the Level of Intimacy (LoI) between an interlocutor and the DI. The LoI is coupled with the number of occurrences that identify the number of relations occurring between the interlocutor and the DI.

The social groups are characterized by: their social values (e.g.: gender, range of age, race, ethnicity, citizenship, religion, social class, level of study, kind of work, etc.), their emotional appeal, and their ethical and moral values.

The social values can be segmented in a more refined way (e.g.: citizenship=“citizen of New York” instead of “citizen of USA”).

The emotional appeal will be catalogued in accordance with the Indoles's emotional parameters (see the Indoles description below) and, for the known person, are collected in the Memories Repository (see the Animus description below).

The ethical and moral values will be catalogued in accordance with the Ethical and Moral Module parameters (see the Ethical and Moral Module description below).

Following the previous Example, the three persons in the room, at the beginning, are catalogued as:

George (identified by DI by the face detection system):
Intimacy status: 1.0 (max intimacy=0; min intimacy=9).
Occurrence score: 132.
Social values: male, 60-75, Caucasian, Scandinavian, US citizen, protestant, middle class, graduate, engineer.
Emotional appeal: vigilance (8)+trust (40)+serenity (22).
moral & ethical values: protestant (high)
unknown person 1 (identified by the face detection system and by means of George's verbal phrase)
Intimacy status: 7.0 (good friend's colleague).
Occurrence score: null.
Social score: male, 40-50, Caucasian, null, null, null, null, null, null.
emotional appeal: vigilance (−6)
moral & ethical values: null
unknown person 2 (identified by the face detection system and by means of George's verbal phrase)
Intimacy status: 7.0 (good friend's colleague).
Occurrence score: null.
Social values: female, 40-50, Asian, null, null, null, null, null, null.
emotional appeal: vigilance (−6)
moral & ethical values: null

The Intimacy Management Engine 320 computes the Total Level of Intimacy (Total LoI) of the “set of interlocutors”: all the single individuals in front of the DI (equal: in relation with the DI at the same time). The Total LoI will be used by the other modules to define the quality of the answer (in terms of content and verbal and non-verbal expressions) released to the set of interlocutors.

Total LoI=SUMMATION, [LoI(i)*vigilance(i)]/number of interlocutors;

LoI (i)=LoI of interlocutor=function (intimacy status, social values, emotional appeal, moral and ethical values);

vigilance₍ᵢ₎=ƒ(network connection₍ᵢ₎=Is a function that represents the weight of vigilance that the DI uses to deliver an answer. The DI computes this weight starting from the quality of connections between the interlocutor(i) and the known network of persons.

This approach allows the DI to set the LoI based on personal parameters of the interlocutor, and the influence of the interlocutor on the social network connected with DI.

The Intimacy Management Engine 320 computes in a recursive way the Total LoI, based on the stimuli received. It starts with a Total LoI (t₀) and it modifies this value based on new information accumulated during the session of dialogue between the interlocutors and the DI. The LoI of each interlocutor will be upgraded in a different way:

1. If an interlocutor is unknown, the information collected during the dialogue can modify the parameters of social group;

2. If an interlocutor is unknown, but the DI collects enough data to identify him/her in a unique way (typically biometrical data) then the intimacy status is upgraded;

3. If the interlocutor is known or unknown, but a known interlocutor with enough intimacy status endorses him/her, he/she can obtain an intimacy status upgrade;

4. If the interlocutor is known, the information collected during the dialogue can modify the parameters of social group and, eventually, the intimacy status will be upgraded;

5. If the interlocutor is known but his/her number of occurrences exceeds a defined threshold, eventually, the intimacy status will be upgraded.

The DI's subject defines all the weight, threshold and other elements used to determine a temporary or lasting variation of LoI.

In the Example, the three persons in the room, at the beginning, are catalogued as shown above. The other information arrived from the Circum are:

“This is George, my friend”+“I am in my environment”+“I want to introduce you to my colleagues”+“Be careful of what you say. These aren't my friends and they can generate problems for me at work”+“They are my friend's colleagues and they are hesitant, but not with a negative impression, about DI”+“My intuition detects that probably one of these colleagues is an honest and righteous man”.

This information will modify the following social values:
unknown person 1 (identified by the face detection system and by means of George's verbal phrase and by a smell detector)
emotional appeal: vigilance (−6)→vigilance (−8)+trust (6)
unknown person 2 (identified by the face detection system and by means of George's verbal phrase)
emotional appeal: vigilance (−6)→vigilance (−8)

The outputs of Circum 200 and Societas 300 are sent to other modules that will decide the opportune answer. To continue the Example, let us suppose that the DI's answer will be “Hi, George. I am glad to see you again. Would you introduce your colleagues to me?”

George says: “Ok! Barry is the new director, he is an engineer and he arrived in the company only two months ago. He is full of energy and new ideas. Daphne works in the Engineering Department also. She is a longtime colleague and good friend. They are really excited to meet you and speak with you.”

This new verbal information (connected with the related non-verbal information), will modify the social, emotional and ethical values in this way:
unknown person 1=Barry
Intimacy status: 7.0 (good friend's colleague).
Occurrence score: null.
Social values: male, 40-50, Caucasian, null, null, null, null, graduate, engineer.
emotional appeal: vigilance (−8)+trust (6)
moral & ethical values: null
unknown person 2=Daphne
Intimacy status: 7.0 (good friend's colleague).
Occurrence score: null.
Social values: female, 40-50, Asian, null, null, null, null, graduate, engineer.
emotional appeal: vigilance (−8)=vigilance (−1)+trust (12)
moral & ethical values: null

The modification of some parameters for “unknown person 1” and “unknown person 2” augments the Total LoI sent to other modules that will compute the opportune answer (more “friendly” than the previous one) . . . and so on.

After some interactions between the DI and the group of interlocutors, the Total LoI is probably stable and, consequently, the quality of relation too.

If the biometrical sensors have collected enough data to recognize Barry and Daphne, they modify their intimacy status with the DI.
unknown person 1=Barry
intimacy status: 7.0 (good friend's colleague)→6.0 (acquaintance)
occurrence score: 1.
Etc.
unknown person 2=Daphne
intimacy status: 7.0 (good friend's colleague)→6.0 (acquaintance)
occurrence: 1.
Etc.

Third Element of Digital Identity: Indoles 400

The third logical element is the Indoles 400. Each DI has a specific emotional and psychological model that can be constructed from those available in the literature or tailored specifically to the user one is representing. The Indoles 400 contain the n-dimensional map of the emotional states and the psychological model that defines the transition rules from an emotional status to another. The Indoles Module 400 includes the parameters to set the correct facial expressions and positions of body and hands for a 2D/3D representation and affects voice synthesis.

Each dialogue is mapped as an n-dimensional point into the map of emotions calculated by means of the emotional tag of a specific memory state received as an input from the Animus.

While Indoles 400 (and Animus 500) receive stimuli from Circum 200 and Societas 300, related outputs are calculated and passed to the Loquor 600 and Corpus 700 modules for the right representation.

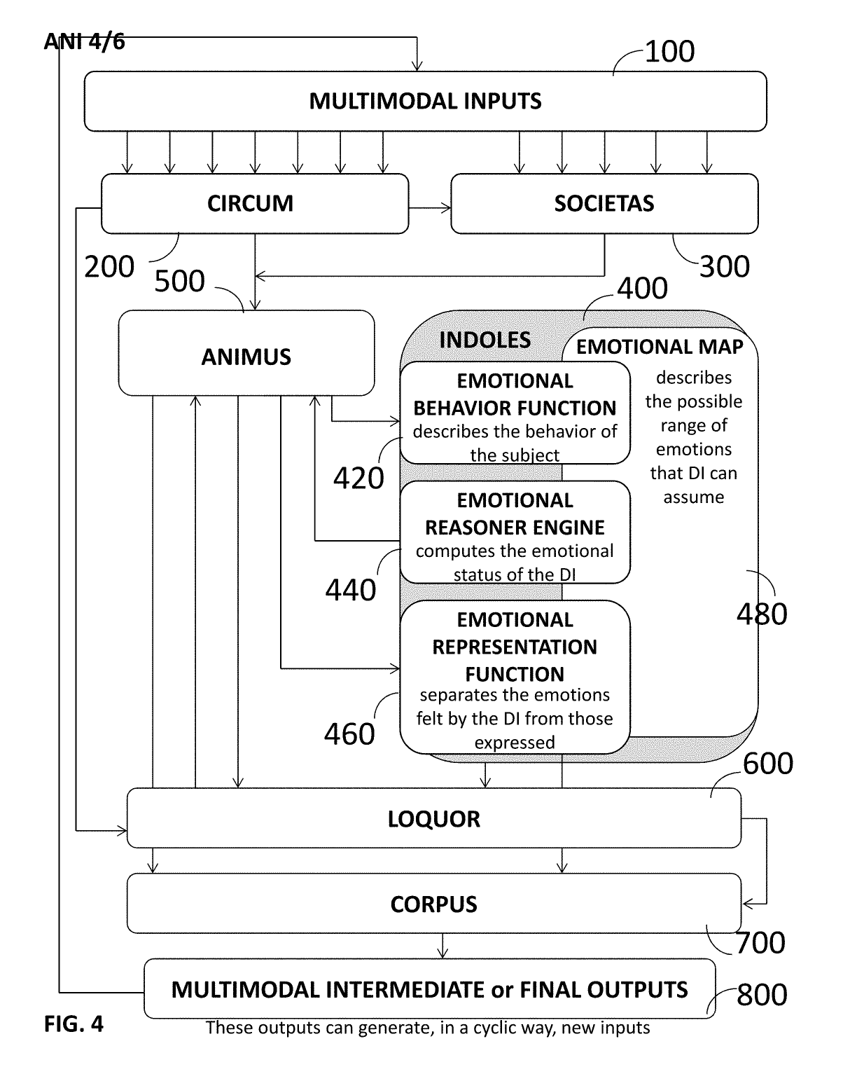

FIG. 4 shows interactions between Indoles and the other logical elements of DI.

FIG. 4 shows that Indoles 400 is composed of four modules:

a) the Emotional Behavior Function 420;

b) the Emotional Reasoning Engine 440;

c) the Emotional Representation Function 460; and

d) the Emotional Map 480.

The Animus 500 sends inputs to the Emotional Behavior Function 420 and Emotional Representation Function 460, while receiving input from the Emotional Reasoner Engine 440. Further, the Indoles sends a general output to the Loquor 600 and a specific output to the Corpus 700 through the Emotional Representation Function 460. The Corpus 700 sends an output to the Multimodal Intermediate or Final Outputs 800, which may then generate further inputs.

The Emotional Map 480 describes the possible range of emotions that DI can assume. This map is unique for all the DIs created, and represents the state of the art of the study on human emotion. The map uses an n-dimensional representation of the Plutchik's Wheel.

The Emotional Behavior Function 420 describes the behavior of the subject into the Emotional Map 480, tracing the possible paths that our subject can follow into the map. For example, if the subject has difficulty expressing joy, her/his possible emotional paths inserted into the Emotional Map could never reach the maximum level of joy allowed (i.e. maximum level of Joy=50, while the user's stops at level 30).

The function of emotional behavior is set during the DI configuration phase, when the psychologists analyze the subject's behavior through an interview, posture analysis and public and private behavior, etc.

The Emotional Reasoning Engine 440 computes the emotional status of the DI, with these main steps:

a) detection of the actual position in the Emotional Map 480;

b) reception of the input's stimuli, fitted and elaborated by Circum 200 and Societas 300;

c) extraction by the Memories Repository (see below in the Animus element) the emotional values related at the ongoing dialogue;

d) computation of the next position in the Emotional Map 480 function of: actual position, emotional values received from Circum 200, emotional values received from Societas 300, emotional values extracted from Memory Repository.

In absence of any kind of stimuli, the engine computes a new position on the emotional map for each time fraction. This computation is based on a function of the emotional drift set established during the configuration phase of the DI. That is, the new position on the emotional map is a position on one of the possible paths outlined in the emotional map for this particular DI. This concept is explained in more detail in the following example.

Going back to the previous Example: at the beginning of the conversation, before the DI discovered the interlocutors, it had the following emotional state. The Plutchick Wheel will be represented by a four-dimensional axis, each with boundaries [−40, +40]:
joy/sadness axis [0], that represents a neutral condition with respect to this axis;
trust/distrust axis [0], that represents a neutral condition with respect to this axis;
fear/anger axis [0], that represents a neutral condition with respect to this axis;
surprise/anticipation axis [0], that represents a neutral condition with respect to this axis.

After a lapse of time the Emotional Reasoning Engine 440 modifies the original emotional status (i.e. a situation of boredom with a little annoyance):
joy/sadness axis [0];
trust/distrust axis [−22];
fear/anger axis [−21];
surprise/anticipation axis [0].

When the interlocutors are discovered, the emotional state becomes a situation of anticipation mixed with a little apprehension for the new visitors:
joy/sadness axis [0];
trust/distrust axis [0];
fear/anger axis [22];
surprise/anticipation axis [−15].

After the elaboration of the first round of stimuli through Circum 200 and Societas 300, the emotional state elaborated by the Emotional Reasoning Engine 440 becomes:
joy/sadness axis [22];
trust/distrust axis [+18];
fear/anger axis [30];
surprise/anticipation axis [−5].

This emotional status: “elevated vigilance, generated by George's verbal and non-verbal messages, combined with a serenity and trust, due to the presence of a good friend, and a little apprehension due to the subject's personality” is used to compute, according to the Animus, the next answer . . . and so on.

The purpose of the Emotional Representation Function 460 is to separate the emotions felt by the DI from those expressed. In the process of the present invention the stimuli are sent simultaneously to the Indoles modules and to Moral & Ethical modules (see Animus described below). The outputs of the modules will be sent to the Decisional Engine (see again Animus) to decide the DI's correct status (and consequently the answers and outputs) for the received stimuli. The DI's status contains the correction parameters of emotional behavior. These parameters are used to compute the emotional representation showed by DI, in other words the function computes the new point in the Emotional Map.

The Emotional Representation Function 460 defines the boundaries, in the Emotional Map 480, of the emotions that the DI is able to show.

Similarly to the Emotional Behavior Function 420, this function is set by psychologists during the DI configuration phase.

During the computation of the next answer, the Decisional Engine of the Animus 500, sends the emotional values connected to the answer to the Emotional Representation Function 460. For simplicity, let us suppose that these values aren't changed with respect to those presented above.

The Emotional Representation Function 460 modifies these values in a way to show the external emotional behavior of the subject. In the Example, if the subject is a personality classified as “I won't” (typically a soldier or other person who is expected to express little emotion in response to stimuli), his/her emotional values become:
joy/sadness axis [22];
trust/distrust axis [+18];
fear/anger axis [−25];
surprise/anticipation axis [−5].

This external emotional status becomes: “elevated vigilance, combined with serenity and trust, and a little unfriendliness, due to the subject's personality”.

In this way the DI can use the emotional status, computed by the Emotional Reasoning Engine 440, to influence the Animus's decision about the answers. The new emotional status, computed by the Emotional Representation Function 460, defines the external appearance of the DI.

Fourth Element of Digital Identity: Animus 500

The Digital Identity core is the Animus 500: it is the representation of the subject's memories, of its capacity to compute a decision based on the data known, and his/her ethical and moral values. The Animus 500 is structured around a storage and computing system in which the subject's memories are related to the subject's emotions, his/her sensations, his/her prosodic, lexical, moral, religious and psychological characteristics and other personal attributes connected with the memories.

The Animus 500, together with Indoles 400, receives data from Circum and Societas. They process these inputs and pass the results to the Loquor and Corpus for the right representation of the answers.

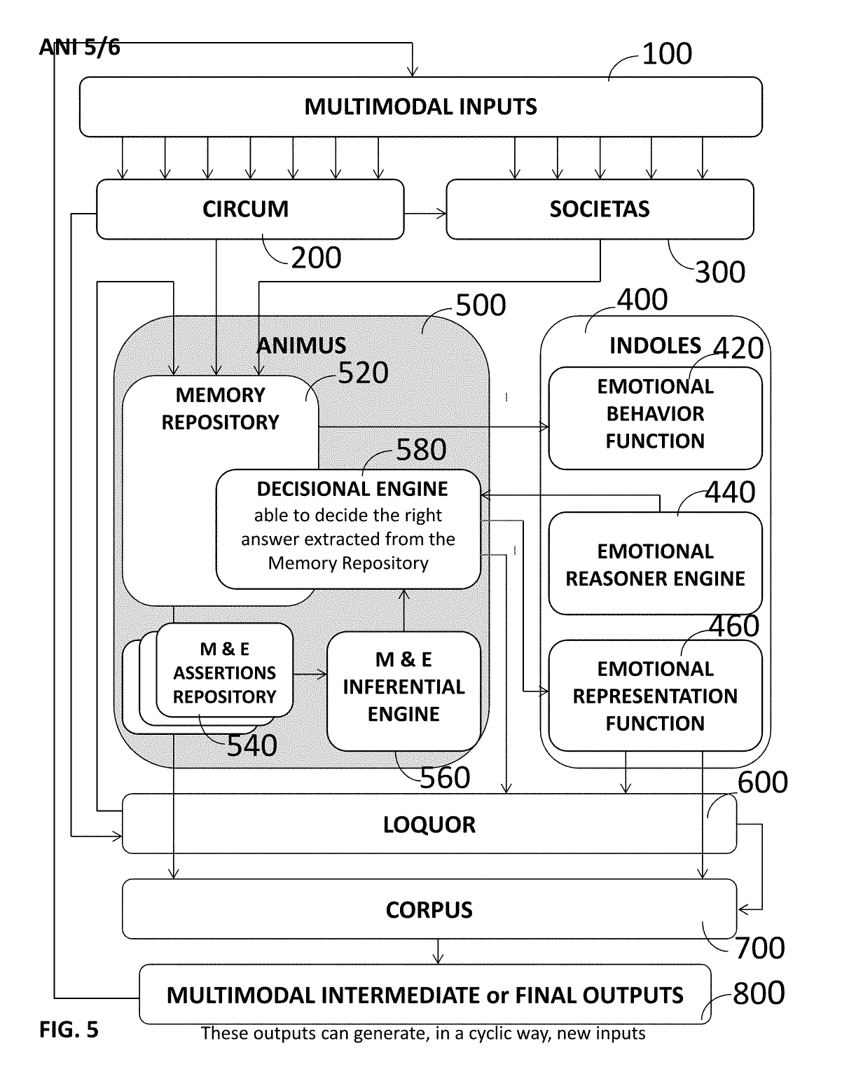

Relationships between Animus 500 and other elements are described in FIG. 5. The following represents a high level overview of the Animus 500 shown in FIG. 5. In brief, the Animus 500 comprises four components: the Memory Repository 520, the M&E Assertions Repository 540, the M&E Inferential Engine 560, and the Decisional Engine 580. The Memory Repository 520 receives inputs from the Circum 200, Societas 300, and Loquor 600. The Memory Repository 520 sends an output to the M&E Assertions Repository 540, which sends an output to the M&E Inferential Engine 560, which sends an output to the Decisional Engine 580. Further, the components of the Animus 500 interact with the components of the Indoles 400. The Memory Repository 520 sends an output to the Emotional Behavior Function 420 of the Indoles 400. The Decisional Engine 580 receives an input from the Emotional Reason Engine 440 of the Indoles 400 and sends an output to the Emotional Representation Function 460. The Animus 500 also sends an output to the Loquor 600 through the Decisional Engine 580 and sends an output to the Corpus 700 through the M&E Assertions Repository 540. The Corpus 700 sends an output to the Multimodal Intermediate or Final Outputs 800 which may generate new inputs.

The memories are perpetuated and stored in the Memory Repository 520, a highly structured organic framework based on multiple levels of information.

i. The first set of components regards the subject's personal biography: a catalogue of the person's memories. The information contained includes all the data necessary to contextualize the memory: timestamp of memory insertion, localization, timeframe of memories (age of the subject), taxonomic classification of the memory, connection with other memories and references to the different topics, etc.

ii. Each biographical memory may have a different form. The memories of the subject may be structures in the form of the subject's sentences (texts), subject's narration of an experience (texts), external document, videos, images, verbal audios and music, etc.

iii. Each memory also contains other resources such as specific smells or other sensorial stimuli such as sounds, taste and flavor descriptions, tactile descriptions, etc. . . . connected with the Circum 200 element.

iv. Each memory includes the identified people involved in the memory and its affiliation, at a relation level, to a specific socio/demographic group. This information, joined with Societas's data, allows the right level of disclosure of the memory to be set.

v. The last set of Memory Repository 520 contains the emotional, ethical and moral values and tags which are used, based on predetermined models, to compute the emotional and moral reaction applicable to each specific memory.

In order to protect the private data of the subjects, the Memory Repository 520 preserves the memories using encryption techniques with public or private keys.

The memories are catalogued by means of different ontologies related to the subject. The search (and extraction) of the memories related to an input stimulus is developed using the subjective semantic analysis of the input stimulus (see Loquor 600 described below).

The Animus 500 also includes the following different computational modules:

i. A Moral and Ethical Module that holds the ethical and religious rules fitted to our subject.

ii. A Decisional Engine 580 to compute the right answer based on:

a. the input's stimuli manipulated from Circum 200 and Societas 300,

b. data from the Moral and Ethical Module,

c. the emotional values computed by the Emotional Reasoning Engine 440 (see Indoles above described),

d. the subject's memories and biography.

This approach enables the generation of a specific response adapted to a determined situation, question and/or stimuli even if they are already known and classified in the Animus 500, or never encountered before (not classified in the Animus 500 memories or biography).

The Moral and Ethical Module (M&E Module) is composed of two main components: the M&E Assertions Repository 540 and M&E Inferential Engine 560.

The M&E Assertions Repository 540 is a database of sentences that define the positive or negative value of an action or a thought. The set is divided in subsets, each of these representing a collection of sentences unified by a moral (e.g.: the Four Gospels, the Holy Bible, the Critique of Pure Reason, the Constitution of the United States, the Way of Bushido, the Vegan Style of Life, etc. . . . ). Each subject can have more than one moral (including sentences in contrast) and especially preferred are such morals emanating from one or more sources.

Modification of the standard morals or creation of new morals will be applied during the memories data collection phase.

The database is indexed in a way to simplify the research of sentences.

When a memory is stimulated by the inputs, the M&E Inferential Engine 560 searches for sentences that can be provided as possible responses/answers/arguments in the database of the M&E Repository 520. The responses/answers/arguments are identified by the tags or by the values stored in the M&E Repository 520 and connected with the specific memory. The M&E Inferential Engine 560 applies a sentiment analysis on the sentences to evaluate the positive or negative relevance of the stimulus and of the related memories.

The results of this analysis may increase or decrease the moral and ethical relevance of the stimulus.

Always using as a guide the Example mentioned above, the input stimuli generated from Circum 200 and Societas 300 are, Barry says: “Nice to meet you, I'm very excited to speak with you. You are very realistic and I'm curious to better understand your performance. In the past I was interested in the cryogenic process but it did not convince me.”

These stimuli activate in the Memory Repository 520 the memories related to the concepts:

PREVIOUS: “Barry”, “new colleague”, “engineer”, “full of energy”, “new ideas”, “he is excited to meet me”, “He wants to speak with you”, and other keywords semantic-equivalent.

ACTUAL: “curious”, “immortality”, “cryogenic process did not convince him”, and other keywords semantic-equivalent

From the Memory Repository the memory extracted will be, in a simplified example:

“I like curious minds but not curious persons”, “I feel tentative to obtain immortality of my memories, of my moral values and transmit my experiences to others”, and “A cryogenic process is a way to find immortality. The process consists of hibernating the body . . . ”, etc.

As moral and ethical attributes of the memories, the only one indexed is the Holy Bible with a high level of relevance for the subject. By means of the sentiment analysis, we can find in the Holy Bible:
different sentences with negative values about the “immortality of the body”
different sentences with negative values about the “research of immortality for humans”
different sentences with high positive values about the “research of immortality for the soul”
different sentences with little positive values about the “preservation of the memories”
etc.

These data about the actual stimulus, together with other stimuli and related information, are transmitted to Decisional Engine.

The Decisional Engine 580 is an A.I. engine able to decide the right answer, selected between the memories extracted from the Memory Repository 520, and based on the criteria arrived from Circum 200, Societas 300, Indoles 400 and M&E Engine 580. To follow the main steps of the process to select the best answer:

i. From Loquor 600, the verbal stimuli (phrases) filtered by means of the subjective NLP (see Loquor element below described);

ii. From Circum 200, the non-verbal stimuli (translated in textual descriptions);

iii. From Intuition Engine 260 the memories recalled by the intuition (these memories have a different relevance);

iv. Using the semantic analysis, on texts, tags and descriptions, the Decisional Engine finds, and extracts, all the memories that satisfy the received stimuli;

v. The Decisional Engine 580 starts the computation to identify the best answer based on the selected memories. For the computation the Decisional Engine 580 compares the output of other modules with the attributes of each selected memory:

a. The Total LoI (output of Societas 300) establishes which among the selected memories are compatible with the interlocutors;

b. The outputs of Indoles that permit it to obtain the emotional status of the DI related to the present stimuli and the emotional status of the DI related to each memory adopted as a possible answer;

c. The outputs of the M&E Engine 580 that permit it to recognize the moral and ethical values related to the received stimuli;

d. A dedicated algorithm compares the relevance of the emotional impact of the stimuli and the related memories, with the relevance of their own moral impact. This algorithm is set by psychologists during the analysis of the subject's personality phase of the DI configuration;

e. The algorithm's result can modify the Total LoI value. In this case the steps b will be repeated and if we obtain a new set of selected memories, the steps c. and d. will be repeated up to obtain a stable result.

Fifth Element of Digital Identity: Loquor 600

The fifth element is Loquor 600: representing the dialogical capacities of Digital Identity.

This capacity is divided into two main branches: one devoted to understand the verbal and non-verbal languages of the interlocutors and the other one to express, by means of verbal and non-verbal languages, the answers and reactions to the input stimuli.

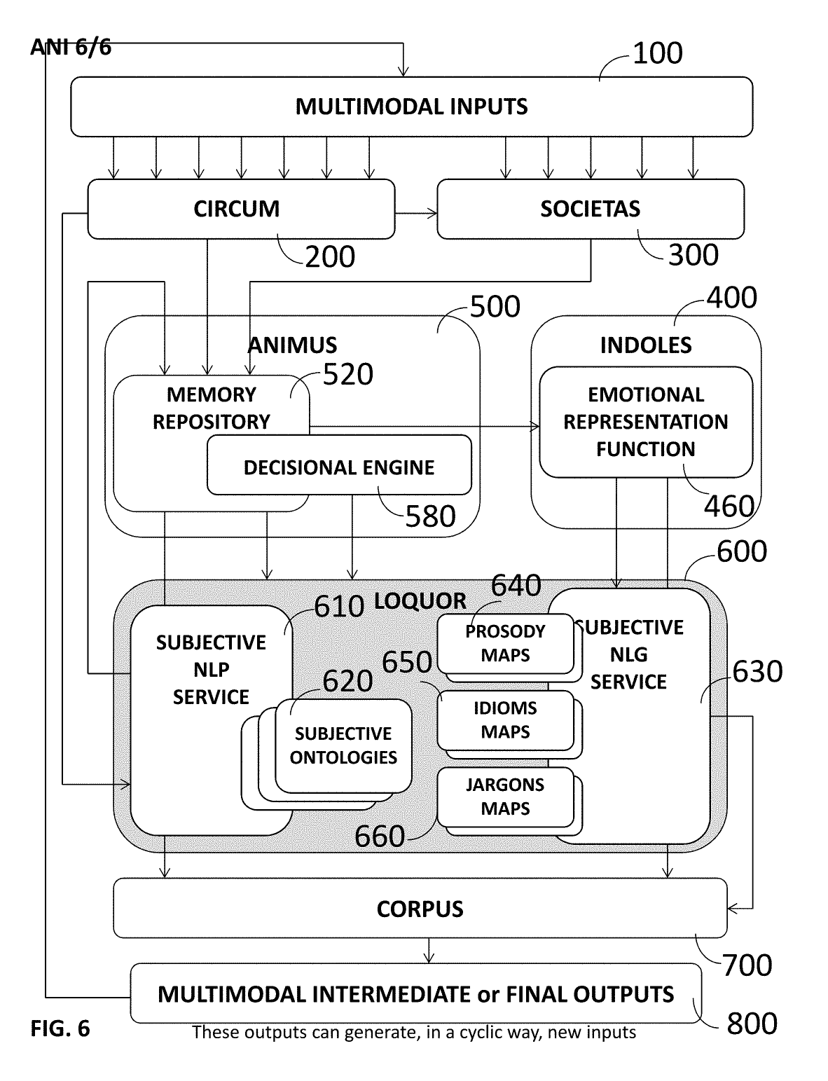

The interaction between Loquor 600 with the other logical elements of DI is shown in FIG. 6. The following represents a high level overview of FIG. 6. First, the Loquor 600 receives general input from the Memory Repository 520 and Decisional Engine 580 of the Animus 500. Second, the Loquor 600 contains both the Subjective NLP Service 610 and the Subjective NLG Service 630. The Subjective NLP Service 610 is associated with Subjective Ontologies 620, while the Subjective NLG Service 630 is associate with Prosody Maps 640, Idioms Maps 650, and Jargons Maps 660. Further, the Subjective NLG Service 630 receives specific inputs from the Emotional Representation Function 460 and sends an input to the Corpus 700. The Subjective NLP Service 610 receives an input from the Circum 200 and sends an output to the Memory Repository 520 of the Animus 500 and the Corpus 700. Further, outputs from the Memory Repository 520 and Emotional Representation Function 460 pass through the Loquor 600 to the Corpus 700.

The first Loquor's branch is Subjective NLP Service and Ontologies 610. It's devoted to the identification of meaning of an input's stimuli, not only based on generic language ontologies and a NLP (Natural Language Processing) system but also capable of creating a connection with the individual's ontologies of the Digital Identity. In fact the state of the art technology is based on understanding a concept with the goal of identifying one or more answers based on the following process: a) the system receives and interprets (voice or text) input by means of an NLP service and uses the related ontologies in order to deduce the “common meaning” of the phrases and b) using results acquired in the previous step, solves the input by means of searching and extracting the contents from the knowledge base, e.g., Memory Repository.

Loquor 600 provides a new approach to understanding, where the system:

a) receives the input (verbal or text) and, by means of a subjective NLP and subjective ontologies, understands the “common meaning” and the “intimate meaning” of the phrases (that can be very far from the “common meaning”) and

b) solves by means of searches and extractions of contents into the subject's memories.

Using this innovative approach, the system produces an answer consistent with the Digital Identity subject, and, overall, ensures that the question understanding process is tailored to the DI subject.

To solve point a), a multi-level catalogue of the different ontologies related to the subject is created: where the native language spoken by the subject (Language Ontology) is mandatory. In addition, other optional ontologies are created: one dedicated to the subject's individual expertise and environment (Cultural-Group Ontologies), those regarding social dialogue (Social Dialogue Ontology), and those created especially for a specific user (User Ontology). A subjective NLP service uses the previous ontologies to understand the “common meaning” and the “intimate meaning” of the verbal and non-verbal messages.

Example of Subjective NLP and Subjective Ontologies:

Someone in the DI's family tells the DI: “Today it's raining”. The Loquor assigns this sentence the meaning “Today the family is nervous”; this is because in the family's lexicon this is the right, and most common, interpretation of the assertion. Obviously, if the source of assertion belongs to a more external social circle, the interpretation of the Loquor will be aligned with the native language dictionary.

Other Examples of Subjective NLP and Subjective Ontologies:

Someone says something about a raincoat. For our subject a raincoat is linked to a singer-songwriter (because the subject is a Leonard Cohen fan) and Paris (because only in Paris the subject had used a raincoat and, for him, many Parisians wear this kind of cloth).

The second Loquor branch is the Subjective NLG Service and the Related Library 630. They are devoted to express, by means of verbal and non-verbal languages, the DI's answers and reactions and are connected with the NLG (Natural language Generation) service. The main components of this branch are the different types of libraries:

i. the library of phonemes for the Text-To-Speech customized on the subject;

ii. the library of the facial expression, customized on the subject.

Both the libraries can have some special add-ons including:

i. Prosody 640 is a matrix that transforms the emotions (received from the Emotional Representation Function) in a sequence of verbal and non-verbal elements selected from the libraries;

ii. Idioms 650 & Jargon Maps 660 are special sub-libraries that collect the typical expression of the subject. Similarly, to the NLP branch 610, Idioms 650 & Jargons Maps 660 are divided into five categories: universal, local, sectorial, relative and personal.

In this way, the DI can change the level of formality of the output language based on the DI behavior, the argument being made, and on the interlocutors. The default lexicon is more nested (personal) and according to the context level rises towards the broader level; it is therefore necessary that each element of the nested lexicon must have the semantic correspondence to the upper level. The NLG service 630 can decide when and how much information is lost in comparison to how much the receiver makes them understood by lowering the level of formality.

In Example of Applications:
the DI is a “teacher” with the goal of maximum understanding for the common interlocutors: the language will be, for the main part, the universal one;
the DI is a “teacher” with the goal of maximum understanding for the interlocutors with the same specialized skills: the language will be, for the main part, the sectorial one;
etc.

From this point of view idioms and jargons are different: the idioms are verbal translations that do not lose informational value but which approach or retreat to people of a certain social/cultural level (special categories of idioms are the proverbs and metaphors), while Jargon can produce a loss of information if used at the wrong social/cultural level.

Sixth Element of Digital Identity: Corpus 700

The last element is the Corpus 700: it is the presentation layer of each Digital Identity that is a hyper-realistic representation of the subject. It is obtained through different advanced techniques capable of best representing both the physical characteristics (bone, muscle and the skin) and the voice (inflection, changes in tone, etc.) of the user.

The presentation layer can be static or can change in time. It can move (change emotion, voice inflection, posture and gesture) based on the indications it is given by the Animus and by the dialogical state.

The presentation layer communicates with the Animus 500 through a communication protocol that enables the decoupling of the presentation layer, based on the technology, from the decisional one tied to the Animus 500. This protects the entire system from technological obsolescence due to the adoption of audio/video presentation components destined to be surpassed.

### Example 1: Hardware and Software Architecture

This Example describes a hardware and software architecture for the creation of a digital artifact from a historical/live/fictional/real persona which represents his/her physical and psychological features. The digital artifact can manage a dialogue with a human interlocutor (or another digital system), react to incoming stimuli and show its proper behavior and emotions.

The digital artifact includes a hardware-dedicated machine and its related software components capable of supporting a process for capturing the features, physical and psychological, of a real persona (historical or fictional character or a living one) and, at the end of the acquisition process, reproducing the persona with the ability to interact, in real time, with one or more users. The artifact can be subdivided into different autonomous hardware modules:

the character's memories module (corresponding to the element 520: “Memory Repository” showed in FIGS. 5 and 6);

the character's physical static and dynamical features module (corresponding to the element 700: Corpus showed in FIGS. 1, 4, 5 and 6); and

the module of the emotions and of the reasoning of the character (corresponding to the element 580+440: “Decisional Engine”+“Emotional Reasoner Engine” shown in FIGS. 4, 5 and 6)

These three different autonomous modules permit each single set of features of the digitalized real person to be applied to different outputs or actuator entities. Connected together, the modules create a complete, intelligent and interactive 3D digital artifact copy of the real persona or person, including features such as physical aspects of the real, historical, or fictional person.

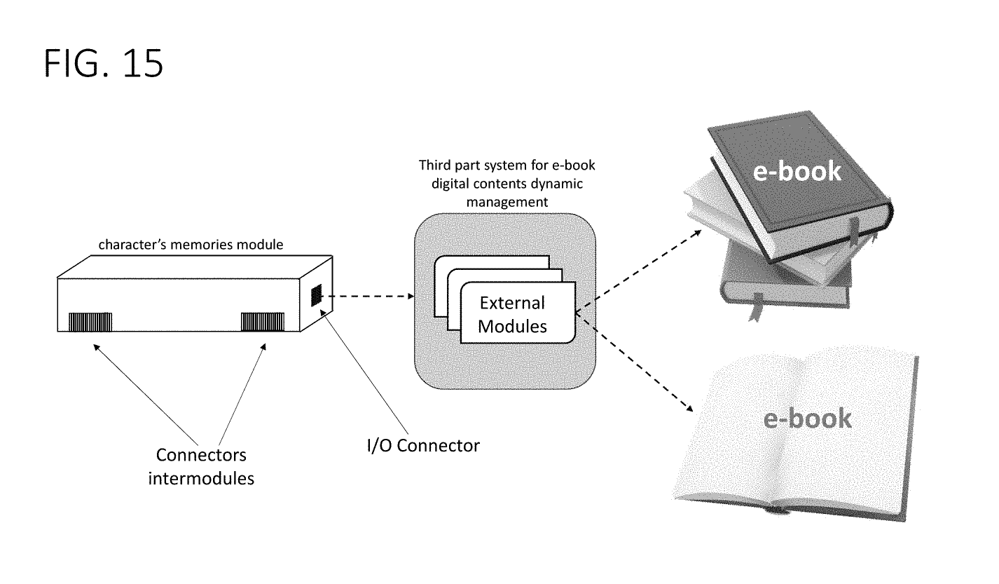

An example of the use of a module that can be used for the character's memories module is an additional device of a digital book for students which quickly adds a lot of certified information regarding the selected historical character (shown in FIG. 15).

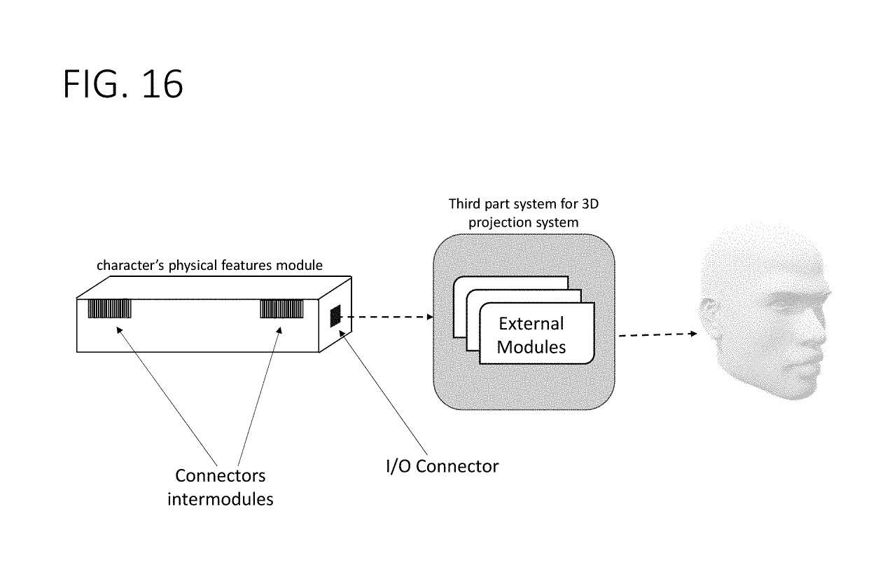

Alternatively, the character's physical static and dynamical features module can be connected to a holographic projection system, to a smartphone, to any display device, or to a robot copy of the original person in order to reproduce the character/robot, consistent with the original real person regarding physical aspects of the person such as body movement and face and hands expression, as a tutorial in a museum or a social application (shown in FIG. 16).

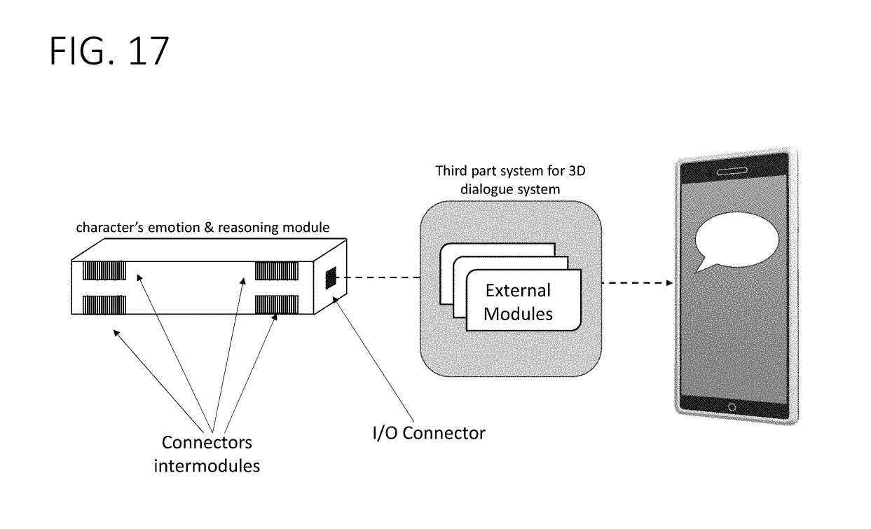

As a final example, the character's emotion and reasoning module can be used to add to a physical or digital artifact (e.g. a shop window or a mobile app) the capacity to communicate with the interlocutor in the same way of the original reproduced person (shown in FIG. 17).

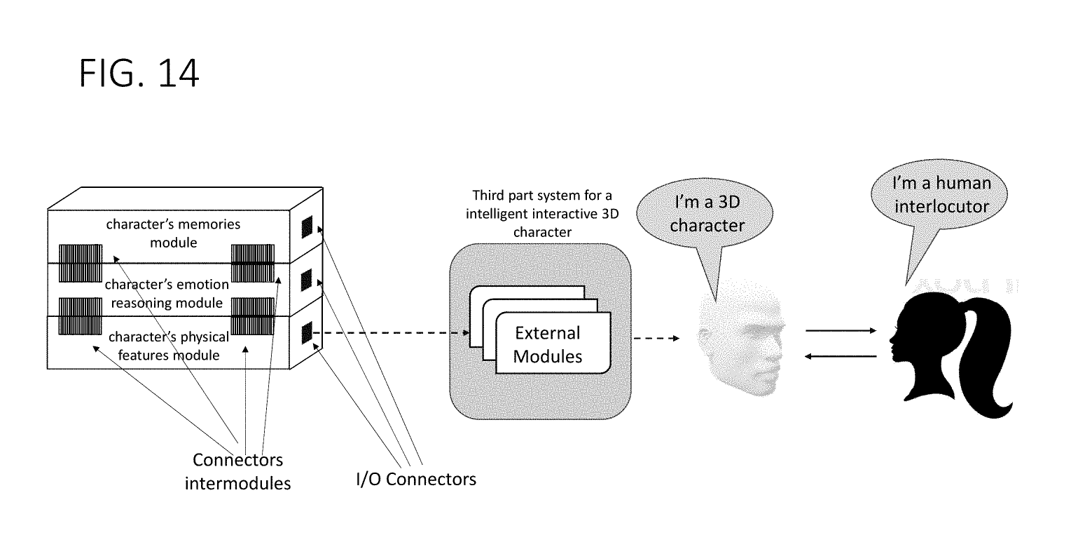

Using the three modules together, a complete 3D intelligent, interactive character can be obtained with memories ready to connect to a presentation system, such as a computer monitor, a television, or a projector (shown in FIG. 14).

One or more of the modules can be provided with a universal clock and a GPS or other global positioning system.

The character's memories module (corresponding to the element 520: “Memory Repository” shown in FIGS. 5 and 6) is a dedicated module for the character's memories, originally structured in order to accept, categorize and store all the relevant data relating to the character. This data can include: documents (3A), opus (3B), letters (3C), or other text (3D), plus video sequences (3E), pictures (3F), recorded or live speeches (3G) and other types of multimodal contents available.

The module of character's memories is structured in a single, transportable, hardware unit module with dedicated storage input connectors and dedicated I/O connectors.

A blockchain, multi-chain or another similar process for monitoring digit-strings-chain can be introduced in order to guarantee the quality and the originality of the inserted data.

The inputs are devoted to receive the persona data of the subject. The data are selected and manually processed (3H), using dedicated content management tools, by experts to guarantee the most precise representation of the persona of the subject.

The storage input's connectors are the standard connectors that allow the module to be connected to a network (private, public, local or global) where the content management tools are located.

The data collection is expected to be vast in terms of both quantity and nature (category, 3I) of data. The data are encrypted, compressed and categorized based on their typology, in order to preserve the security and to optimize search and recovery.

All the data are stored with a tag of absolute time and universal position.

All the data are stored in the form of neutral elements with respect to time and universal position. In this way, the data can be contextualized by local time and local position during the real time presentation.

An ad hoc computational unit prepares the inputs of a search query of the information stored in the memories module and prepares it for the output.

I/O's connectors are the standard connectors that permit the data stored in the module to be sent and received to/from an external computational layer (a pc or the computational unit of a robot or other dedicated computational unit) in order to elaborate on the data for presentation.

Each external computational layer must be provided with a proper software package in order to correctly manage the data received from the module of character's memories.

Additional memory modules can be created and distributed in order to reproduce the memories of the real persona, by means of an external computational layer and a presentation layer (e.g. a standard pc plus a LCD monitor and holographic projection).

For example, the character's memories module of Leonardo da Vinci can be created as a black box in the cloud and this character's memories module can be used as an additional device of a digital book for students in order to quickly add a lot of certified information usable as a knowledge base for detailed Q&A regarding the historical character.

The Character's Physical Features Module (corresponding to element 700: “Corpus” shown in FIGS. 1, 4, 5 and 6) is a dedicated module for the character's physical features, originally structured in order to accept, categorize and store all of the or some relevant data regarding the character. The physical features include all of the or some information usable to reproduce a 3D digital artifact copy of the real, historical, or fictional persona or person such as physical aspects of the real person, such as skeleton, body structure and shape, face structure, hairs, eyes, and so on. Dynamic features can include one or more of postures, gesture, facial expressions, body animation, hands animations, and so on.

The module of the character's physical static and dynamical features is structured in a single, transportable, hardware unit module with dedicated storage input connectors and dedicated I/O connectors.

The inputs are configured to receive the real persona data. The data are selected and manually processed, using dedicated content management tools, by experts to guarantee the most precise representation of the real persona.

The storage input connectors are the standard connectors that allow the module to be connected to a network (private, public, local or global) where the content management tools are located.

The data collection is expected to be vast in terms of both the quantity and nature of data. The data are compressed and categorized based on their typology in order to optimize their search and recovery.

An ad hoc graphic computational unit is configured to prepare the inputs for a search of the information stored in the memories module and prepare the information for output.

For each persona more than one representation can be stored; in this way the customer can select the right representation for the desired goal. As one example, a representation of Benjamin Franklin can be stored as young, adult, or elder.

The graphical computational unit automatically permits a downgrade, in terms of geometrical elements, of the 3D elements (always created or captured in high quality definition) in order to collect more than one physical model of the real persona for use in different presentation systems (for example: high quality for a 4 k projection and low quality for a mobile device projection).

I/O connectors are the standard connectors that permit the data stored in the module to be sent to/from an external computational layer (a pc or the computational unit for a projection system or the computational unit for a mobile device) in order to transfer data for the presentation.

Each external computational layer must be provided with a proper software package in order to correctly manage the data received from the module of character's physical features.

Additional physical features modules can be created and distributed in order to reproduce a 3D digital artifact copy of physical aspects of the real persona, by means of an external computational layer and presentation layer (e.g.: a standard pc plus a LCD monitor and holographic projection).

For example, the character's physical static and dynamical features module can be created to represent Leonardo da Vinci for a museum for use as a virtual guide capable of helping discover art exhibitions.

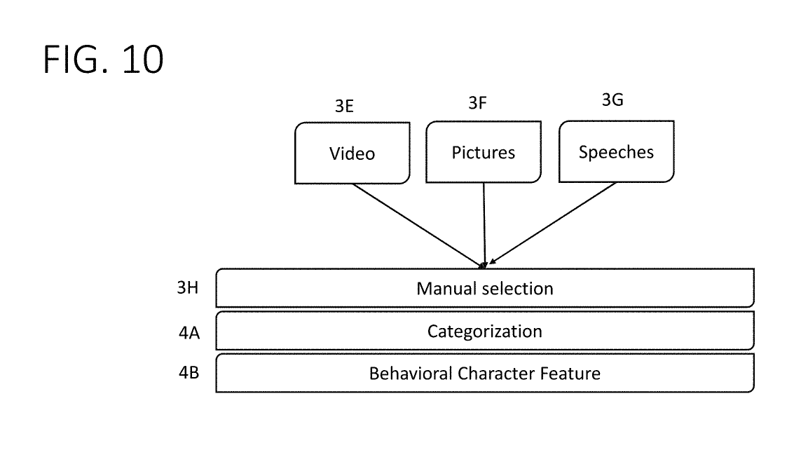

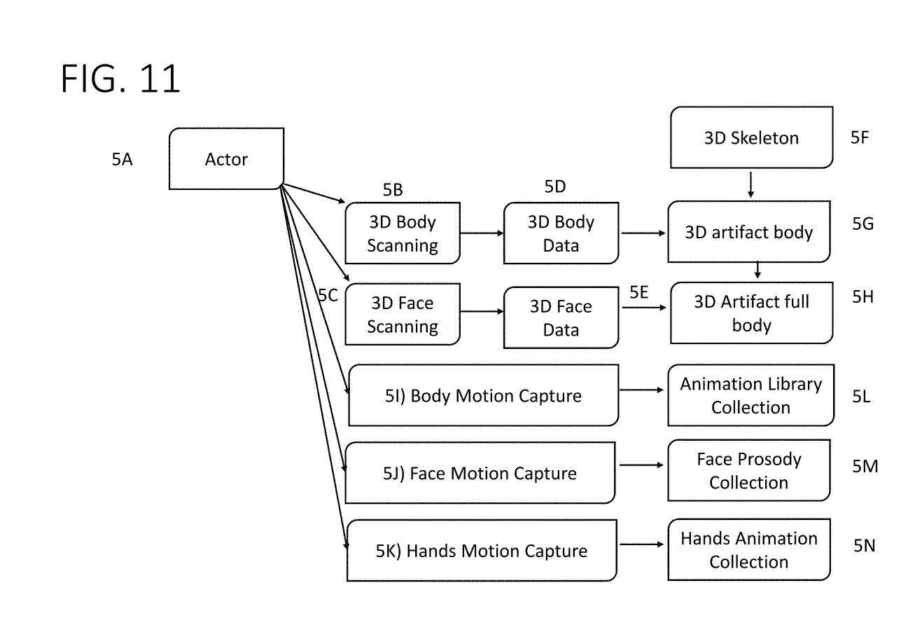

Face, Body and Hands Creation Process (FIGS. 10 and 11)

Videos, pictures & audio (manually processed) can be used to extract physical characteristics and behavioral information (shown in FIG. 10).

The physical characteristics retrieved by the sources in 3E, 3F and 3G. can define the Physical Character Feature (4A), and the behavioral information can define the Behavioral Character Feature (4B).

This data (4A and 4B) are used to identify a real actor to mimic the real persona behaviors and to represent the physical features derived from the selected memories, such as age, body type, height, weight, ethnicity, and so on.

The actor (5A) can be processed through the following (shown in FIG. 11): Body scanning (5B), face scanning (5B) and motion capturing sessions (5C).

3D Body scanning (5B) is a process capable of generating the physical characteristics of the 3D model. Once a scan is taken (using a device called a 3D body scanner), the scan data is used to generate measurements, along with a three-dimensional view of the body.

The output of whole body scanners is a cloud of points, which are typically converted into a triangulated mesh. This step is used to support the 3D visualization of the surface and the extraction of meaningful anthropometric landmarks and measurements (5D). The same process is used to acquire face details (5C) to obtain the 3D Face Data (5E).

To complete the 3D artifact features a 3D skeleton is designed (5F) and covered with the 3D data obtained in 5D and 5E, in order to obtain a 3D Artifact Full Body (5H).

The next steps are the three separate Motion Capture sessions, a Body Motion Capture (5I), a Face Motion Capture (5J) and Hand Motion Capture (5K). Motion capture is the process of recording the body and face movements and is used for recording actions of human actors and using that information to animate the 3D digital artifact. All the movements and facial expressions recorded are stored in three separate collections of various short (from 1 to 20 seconds) 3D animations to generate the Animation Library Collection (5L) and Hands Animation Collection (5N) and Face Expressions Collection (5M).

The 3D model obtained before (5H) is manually refined to improve the texture quality and add details (e.g. skin textures, beard, hair, and so on). Memories are used to define the character outfit. The character can show one or more outfits.

The results of the activities of the body, face and hands animations can be stored in the libraries of the Character's physical and behavioral features module.

The Module of the Character's Emotions and Reasoning (corresponding to the element 580+440: “Decisional Engine”+“Emotional Reasoner Engine” shown in FIGS. 4, 5 and 6) is structured in order to accept, categorize and store all the computational algorithms and related data and parameters able to reproduce the decisional processes and co-related emotional path the of the subject.

The hardware part of this module is a dedicated standard computer with a proprietary Artificial Intelligence and Artificial Empathy software.

This module can be used to provide the intelligence and the emotion of the subject in two ways: a) in order to add to a physical or digital artifact (a shop window or a mobile app or an anthropomorphic robot) the capacity to conduct dialogue with the interlocutor in the same way as the original reproduced person or b) connect together with the other two modules in order to obtain a complete 3D intelligent, interactive artifact with memories ready to connect to a presentation system.

Starting from the previous dedicated hardware modules plus the software modules shown above the following is described:

General Interactional Mechanism

The intelligent and interactive 3D character based on the three previous modules is able to manage general interaction with the users. The complete interactive architecture is made of: standard hardware, ad hoc hardware and proprietary software components.

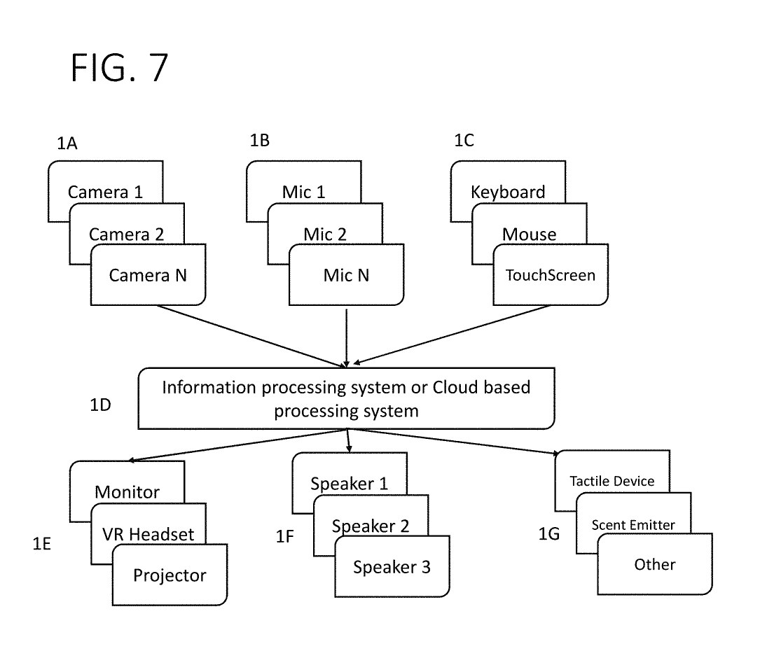

Standard hardware components can be a permutation of the following elements shown in FIG. 7: Input devices (1A, 1B, 1C), pieces of computer hardware equipment used to provide data and control signals connected to an information processing system (1D), with the addition of output devices (1E, 1F, 1G) capable of receiving data and commands from 1D in order to convert the electronically generated information into human-readable form. The hardware bundle, in more detail, can be a permutation of the following elements, where the number of each element can vary from 0, not present, to multiple units.

1A) a camera (or an array of cameras, based on the environment needs)

1B) a microphone (or an array of microphones, based on the environment needs)

1C) an input device (or an array of input devices, as a keyboard, or a mouse, touch detector, or other devices)

1D) an information processing system where the 3D artifact will be pre-loaded, or a connected information processing system to use in cloud distributed software engines.

1E) a presentation hardware, or an array of presentational hardware (e.g., a monitor, a projector, VR headset, or similar device able to represent a 3D artifact)

1F) a speaker, or an array of speakers, to convey voice messages.

1G) other output devices (e.g.: tactile device, scent emitter, or others)

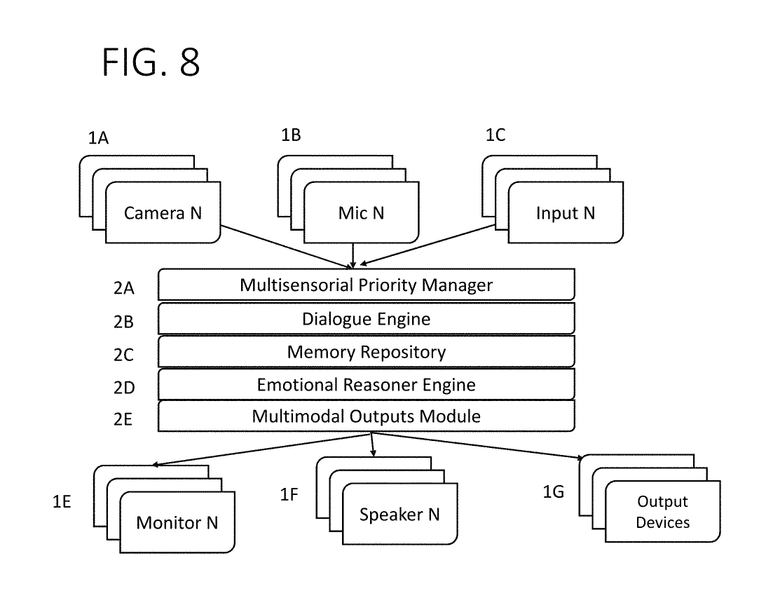

The information processing system (1D) is composed of the following proprietary software modules (shown in FIG. 8):

2A: A Multisensorial Priority Manager

2B: Decisional Engine

2C: Memory Repository

2D: Emotional Reasoner Engine

2E: Multimodal Outputs Module

Some of these software modules are connected or interfaced with the previous described ad hoc hardware modules.

The Decisional Engine and Emotional Reasoner Engine are contained in the Character's Emotional and Reasoning hardware module;

The Memory Repository is included the Character's Memories hardware module;

The Multimodal Outputs Module is interfaced with the Character's Physical features hardware module.

These modules contain all the data and algorithms necessary to create an intelligent and interactive 3D digital artifact copy of the real person or persona such as physical aspects of the real person.

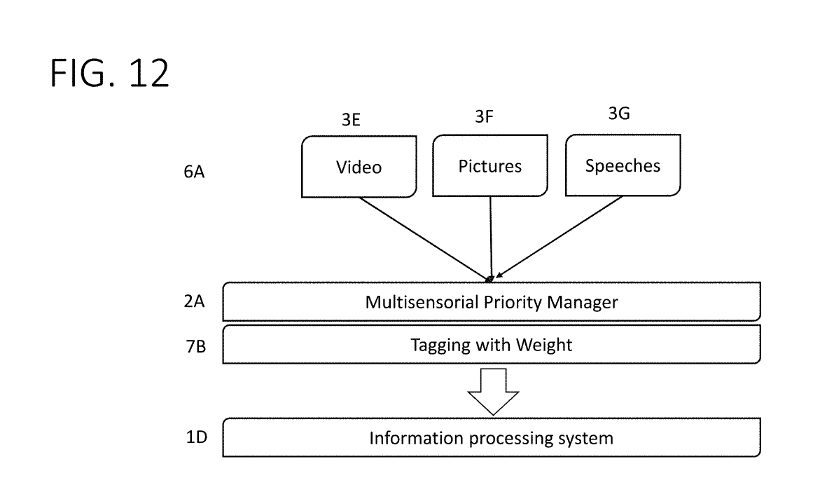

Different than the previous software modules, the Multisensorial Priority Manager (devoted to manage the Multimodal Inputs described above) is supported by standard hardware devices and is capable of defining not only the availability and the sensitivity of a sensor but, based on the manual analysis of the original character is capable of defining the ability of the 3D artifact to prioritize and weight the different stimuli based on his/her original capabilities (shown in FIG. 12).

The incoming stimuli can be acquired from different sources:

Text stimulus: a text received from a connected software client (e.g., mobile application)

Audio: a question received from the microphone.

Video stimuli: images and video received using the connected camera.

The incoming stimuli is collected by one of the sensors (7A) and sent to the information processing system (1D) and passes through the Multimodal Priority Manager (2A). This module can add a weight to the incoming stimuli based on the real character features. For example, a musician will prioritize music with a higher value and speech with a lower value. The customization, for each different 3D artifact, is the ability to handle different stimuli, prioritize them and assign them a different weight. An example of this type of weighting is provided in Example 2 below.

The general interactional mechanisms, for example used in chatbots or interactive avatars, are based on the ability to collect a stimulus through the Multisensorial Priority Manager (2A), send them through the Decisional Engine (2B) and, then using NLP and Semantic Search techniques, compare the output with the most probabilistic answer contained in the Memory Repository (2C). Once the information processing system identifies the best answer, the information processing system collects the information, in terms of knowledge, and the associated emotion (2D) to generate a reply using the Multimodal Outputs Module (2E)

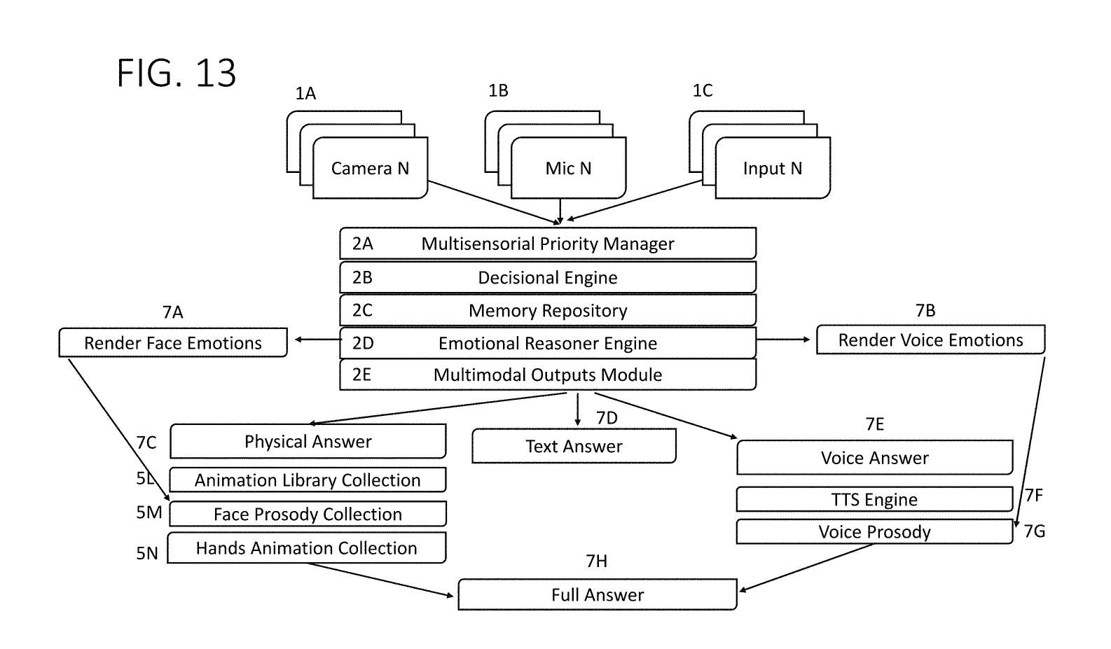

FIG. 13 shows the functions of the Multimodal Outputs Module (2E) in detail. The Multimodal Outputs Module (2E) generates a reply which can include a physical answer (7C), text answer (7D), and voice answer (7E). The physical answer (7C) can be derived from such collections, contained in the Character's Physical Feature Hardware Module, as the animation library collection (5L), face prosody collection (5M) and hands animation collection (5N). The voice answer (7E) can be based on the TTS engine (7F) and voice prosody maps included in the Loquor module (7G). The face prosody collection (5M) and voice prosody collection can be based on the Emotional Representation Function and Emotional Behavior function included in the Indoles module (2D) with the ability to render face and voice emotions (7A and 7B). Together, the physical answer (7C) and voice answer (7G) provide a full answer (7H).

While most of the systems available in the market are generalist, the present invention focuses on the ability to represent, with the highest level of detail, a custom personality to create an artifact capable of mimicking the behavior of an existing real persona.

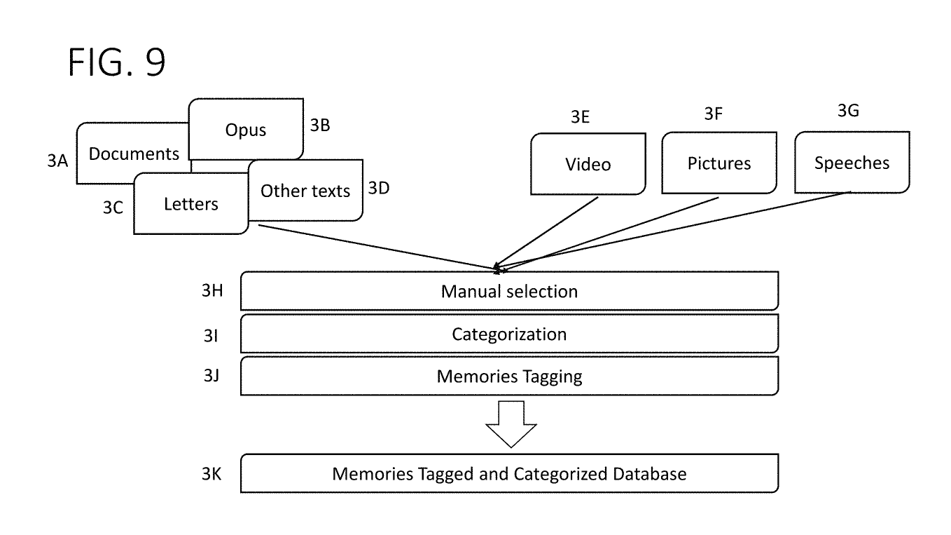

The creative process is based on the ability (shown in FIG. 9) to acquire information (memories) about the subject's persona (historical or fictional character or a living person, to store this information in the Character's Memories module, and to examine these data to customize the interactive modules.

These memories can include documents (3A), opus (3B), letters (3C), or other text (3D), plus video sequences (3E), pictures (3F), recorded or live speeches (3G) and other kind of multimodal contents available.

In order to have data organized and structured in a way in which the data can be used in the system/application, a strict methodology has to be used. Data that are inputted into the system will consist of atomic elements of content. The content data structures will be divided by developing standardized interfaces for each category of atomic element. For example, structure for inputting images will be different than the structure for inputting audio recordings.

All modules that manage information input will have meta-data fields; this process is called ‘Memories tagging’ (3J). These fields (similar to hash-tags) will be important in the Memories Tagged and Categorized Database (3K).

### Example 2: How the Inputs Modify the Emotional Parameters

The qualification of the input stimuli is a dedicated computation of the Multisensorial Priority Engine (MPE) (228) that depends on the subject's knowledge and experience. It represents the subjective filters applied to the inputs in order to qualify their relevance into the decisional processes.

To perform this evaluation, the data coming from the sensor and received by the Multimodal Multisensorial Interface (222) will come from the latter classified with two parameters:

The relevance of the sensor. This will be assigned a percentage value (weight) combined with each type of sensor treated. The default value will be 100%.

The “highlighted inputs” for each type of sensor. These are keywords, tags, signals, concepts representing a subset of the possible data sent by a sensor that for the virtual subject have a particular relevance for which they increase the attention of the 3D digital artifact. The highlighted inputs are set by the experts in the configuration phase of the system and are derived from the personal history of the real subject.

For example, if the virtual subject represented a musician, the sensor that conveys sounds and music should have greater relevance than position sensors or facial expressions.

On the other hand, if the subject for which the DI is created does not pay particular attention to music but some important experience of his life is linked to a particular melody, the “musical” sensor would be set values of standard relevance but the recognition of that particular melody would increase the relevance of the music for the specific input.

Each sensor can potentially send emotional inputs. So there arises the need to manage different emotions from multiple sources. This is performed in two steps: 1) Computation of the weighted average of multiple emotions coming from different sources and 2) Conversion into complex emotions.

To compute the multiple emotions coming from different sources, the MPE performs the following functions:

Given E_{i,x} the value of the emotion i of the sensor x we define: Emᵢ the weighted average value of the emotion i for all the sensors as:

EMᵢ=(Σ_{x=1,n}E_{i,x}*Rₓ)/n where:

i represents the basic emotions collected: happiness, sadness, anger, fear, anticipation, surprise, trust and disgust. The values of basic emotions are defined between (1,100);

n represents the number of sensors that have transmitted significant emotional values. Significant emotional values are a set of emotional values of which at least one is different from the default value (zero);

R represents the reliability of the detection of the sensor x. R is defined as a percentage value.

The results will be the array: EM=(EM₁, EM₂, EM₃, EM₄, EM₅, EM₆, EM₇, EM₈). EM will be the input for the computation of the complex emotion.

To simplify the string analysis of the interlocutor's emotional state, the inventors built a methodology that summarizes the mix of basic emotions in only one complex emotion. In this way, analysis of the emotions' string is simplified. Starting from a list of basic emotions: Happiness, Sadness, Anger, Fear, Anticipation, Surprise, Trust, Disgust, a new complex emotion <emo> is computed with its related appearance value <emo_perc>.

The following explains in detail the steps to compute the unique new complex emotion.

As an example, the following describes computation of an emotion detected by a sensor of Facial Expression recognition.

For the Facial Expression software, the Anticipation (or “Interest”) is detected using the measure of the angle between the center-face (gaze) and the camera. In other words:

If the gaze is perfectly centered to the camera (angle=0°)→Anticipation =100%.

If the gaze is little decentered to the camera (angle <=25%)→Anticipation=75%.

If the gaze is decentered to the camera (angle >25% and angle <=60%) →Anticipation=50%.

If the gaze is widely decentered to the camera (angle >60%)→Anticipation=25%.

If the gaze is opposite to the camera→Anticipation=0%.

The Anticipation value (a percentage value, received by the sensor) will be used as a measure of reliability of the facial expression detection. Indeed, if Anticipation <=25% the values of emotions from facial expression sensor are all 0 (are not relevant).

This step needs to be applied to reduce two emotions (detected by the sensors) to one representative emotion which is the sum of the two. This rule is applied to emotions which are in opposition (for convenience we declare the first “positive_emo” and the second “negative_emo”):

Happiness vs. Sadness

Anger vs. Fear

Anticipation vs. Surprise

Trust vs. Disgust

To compute the new emotions the following rule is applied:

compute ‘perc_positive_emo’−‘perc_negative_{—emo’}

if result >=0→<emo>=‘perc_positive_emo’

<emo_perc>=‘perc_positive_emo’−‘perc_negative_emo’

result <0→<emo>=‘perc_negative_emo’

<emo_perc>=‘perc_negative_emo’−‘perc_positive_emo’

i.e. happiness=65%, sadness=30%→<emo>=‘happiness’ and <emo_perc>=‘35’

After the application of the previous two computational steps the residual basic emotion can be mixed based on the following table (as an example):

At the end the complex emotion <emo> and its related appearance value <emo_perc> transmitted in output to the other modules will be defined as follows:

If the number of basic emotions with percentage value >25% is only one, no complex emotion will be computed. The resultant emotion is the basic emotions with a value more than 25% (and this means that this basic emotion is transmitted in output to the other modules);

If the number of basic emotions with percentage value >25% are two, then the following rule is applied:

<complex_emo_perc>=(<emo_basic_1_perc>+<emo_basic_2_perc>)/<number of emo basic>

i.e. Happiness=70%, Surprise=30%→Wondering=50%

i.e. Anger=50%, Trust=40%→Fervor=45%

If the number of basic emotions with percentage value >25% are more than two, then the following rule is applied:

If two of these are more relevant than the others, that means that these have values are that are more than 33% of the other emotions. Thus, these two will be used to compute the complex emotion;

If only one basic emotion is relevant, then only this is considered as the resultant emotion (no complex emotion will computed);

If no basic emotion is relevant, then this is considered the ‘Neutral’ emotion (with value=0).

i.e. 1) Happiness 72%, Surprise 30%, Fear 76%→Hysteria=74%

i.e. 2) Happiness 72%, Surprise 30%, Fear 35%→Happiness=72%

i.e. 3) Happiness 40%, Surprise 30%, Fear 35%→Neutral=0%

The incoming stimuli is collected by one of the sensors (6A) and sent to the information processing system (1D) and passes through the Multimodal Priority Manager (2A). This module can add a weight to the incoming stimuli based on the real character features. For example, during a dialogue in an environment with musical background, a musician will emphasize the relevance of the musical background with respect to the voice interaction more than an engineer. For the musician, the played music adds more information and will have more relevance with respect to the emotional reasoner computation. For the engineer, probably, the musical background will be detected as noise or with no particular relevance with respect to the emotional reasoner.

The Multisensorial Priority Manager will receive the two input stimuli detected and recognized by the sensors (the voice recognition and the music recognition) and, based to the 3D artifact customization, will assign them different weights. The Emotional Reasoner Module will use this information (input stimuli+weights) as input parameters of its computations.

Returning to the example of the musician, per weight could be music_input=300 and voice_input=700, and for the engineer could be music_input=10 and voice_input=700.

In the computation of the Emotional Reasoner for the musician the music_input will be an important determinant of the output answer.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A system for representing a subject comprising:
one or more hardware module with software, the hardware and software together configured for:
a) storing information as memories of one or more subjects;
b) reproducing, recreating, or mimicking decisional and/or emotional processing of one or more of the subjects based at least in part on information relating to one or more of the one or more subject's memories; and
c) reproducing, recreating, or mimicking one or more physical and/or dynamic features of one or more of the subjects from information relating to the physical and/or dynamic features of the one or more subject;
wherein together a), b), and c) are capable of providing a 3D digital artifact copy of the subject.

2. The system of claim 1, wherein the one or more hardware module is operably connected to one or more computational modules integrable with any digital contents device in order to enrich contents with the subject's memories.

3. The system of claim 1, wherein the one or more hardware module is operably connected to one or more computational modules capable of conducting dialogue with one or more interlocutors.

4. The system of claim 1, wherein the one or more hardware module is operably connected to one or more computational modules capable of reproducing a 3D digital artifact copy of the subject.

5. The system of claim 1, wherein the one or more hardware module comprises hardware with at least one processor and one or more non-transitory computer storage media with one or more documents, opus, letters, text, video, pictures, and/or recorded or live speeches stored thereon.

6. The system of claim 1, wherein the one or more hardware module comprises hardware with at least one processor and one or more non-transitory computer storage media with one or more computational algorithms capable of decisional and emotional processing stored thereon.

7. The system of claim 1, wherein the one or more hardware module comprises hardware with at least one processor and one or more non-transitory computer storage media with one or more physical and/or dynamic features of the subject stored thereon.

8. The system of claim 7, wherein the one or more physical features of the subject comprise one or more of skeleton, body structure and shape, face structure, hair, and/or eyes.

9. The system of claim 7, wherein the one or more dynamic features of the subject comprise one or more of postures, gesture, facial expressions, body animations, and/or hand animations.

10. The system of claim 1, wherein the one or more hardware module comprises hardware with a universal clock.

11. A system for representing a subject comprising:
one or more hardware module with software, the hardware and software together configured for:
storing information as memories of the subject;
reproducing, recreating, or mimicking decisional and/or emotional processing of the subject; and/or
representing one or more physical features of the subject;
wherein the at least one hardware module comprises at least one processor and one or more non-transitory computer storage media having stored thereon:
a) one or more documents, opus, letters, text, video, pictures, and/or recorded or live speeches;
b) one or more computational algorithms capable of reproducing, recreating, or mimicking the decisional and/or emotional processing of the subject; and/or
c) information relating to one or more physical and/or dynamic features of the subject;
wherein the one or more hardware module is capable of generating an interactive 3D digital artifact copy the subject from the information stored as memories of the subject, the information relating to the physical and/or dynamic features of the subject, and/or the reproducing, recreating, or mimicking of the decisional and/or emotional processing of the subject.

12. The system of claim 11, wherein the one or more hardware module is operably connected to one or more computational modules capable of representing a digital book comprising content based on the subject's memories.

13. The system of claim 11, wherein the one or more hardware module is operably connected to one or more computational modules capable of conducting dialogue with one or more interlocutors.

14. The system of claim 11, wherein the one or more hardware module is operably connected to one or more computational modules capable of presenting a 3D digital artifact copy of the subject.

15. The system of claim 1, wherein the subject is a real, living, imaginary, fictional, historical and/or dead human, non-human, person, animal, pet, character and/or avatar.

16. The system of claim 2, wherein the interactive 3D digital artifact copy of the subject is provided by way of a digital book of history enriched with memories of one or more protagonists.

17. A system for representing a subject comprising:
one or more hardware module with software, the hardware and software together configured for:
reproducing, recreating, or mimicking decisional and/or emotional processing of one or more subject; and
presenting the decisional and/or emotional processing of the subject by way of one or more audio and/or visual output.

18. The system of claim 17, wherein the one or more hardware module is configured with:
one or more computational algorithms for performing the reproducing, recreating, or mimicking of the decisional and/or emotional processing based at least in part on one or more of the subject's memories; and
software for reproducing, recreating, or mimicking a 2D or 3D visual representation of the subject based at least in part on one or more physical feature of the subject.

19. The system of claim 17, wherein the subject is a real, living, imaginary, fictional, historical and/or dead human, non-human, person, animal, pet, character and/or avatar.
